(19) United States
(12) Patent Application Publication
(10) Pub. No.: US 2005/0182655 A1
(43) Pub. Date: Aug. 18, 2005

(54) System and methods to collect, store, analyze, report, and present data

(75) Inventors: Steven N. Merzlak, Martinez, GA (US); Majed Tomeh, Bedford, MA (US); Katherine Rowell, Brookline, MA (US); Craig Miller, Holliston, MA (US); Harry Wu, Concord, MA (US)

Correspondence Address: WEINGARTEN, SCHURGIN, GAGNEBIN & LEBOVICI LLP, TEN POST OFFICE SQUARE, BOSTON, MA, 02109, US

(73) Assignee: QCMetrix, Inc., Tewksbury, MA (US)

(21) Appl. No.: 10/933,694

(22) Filed: Sep. 2, 2004

Related U.S. Application Data
(60) Provisional application No. 60/499,445, filed on Sep. 2, 2003.

(51) Int. Cl. G06F 17/60

(52) U.S. Cl. 705/2; 705/3

(57) ABSTRACT

A system and method for collecting and processing surgical data as provided. Hospitals act as local sites and collect data associated with surgical procedures performed therein. The local sites send data to a central site which processes the data and provides recommendations back to the local sites. The recommendations are used by the local sites to improve surgical protocols and procedures.

### CROSS REFERENCES TO RELATED APPLICATIONS

The present application claims the benefit of U.S. Provisional Application No. 60/499,445, filed Sep. 2, 2003. The entire contents of the above application is incorporated herein by reference.

### BACKGROUND OF THE INVENTION

Collectively, U.S. hospitals perform thousands of surgeries each day. These surgeries range from minor outpatient procedures, such as minor hernia repairs, to serious procedures requiring multiple surgeons using sophisticated equipment and precise procedures, such as for organ transplants.

For each surgical procedure, a patient has certain characteristics prior to surgery, referred to as pre-operative conditions, and other characteristics after surgical procedures, referred to as post-operative procedures. For example, a patient may have reduced blood flow and low dissolved oxygen levels prior to undergoing a surgical procedure to remove arterial blockages. After surgery, the patient may have normal blood flow and dissolved oxygen levels; however, the patient may have contracted a post surgical infection.

An individual hospital may, or may not, track patient data with respect to surgical procedures. Statistical data on patients having surgery may be useful to a hospital as such data may facilitate refinement of procedures and protocols. Statistical data from a single hospital is useful; however, having data from several hospitals is more useful as it allows analyses to be performed across more samples.

For U.S. hospitals, having statistical information drawn from every state would facilitate robust and meaningful statistical analyses. Therefore, what is needed is a system for facilitating collection and processing of patient data from across the U.S.

### SUMMARY OF THE INVENTION

The systems and methods to collect, store, analyze, report and present data, such as, for example, surgical data includes information workflow and supporting subsystem infrastructures that can be used at medical centers or any facility requiring integration of data. The embodiments of the present invention include interface protocols for data exchange between facilities and a centralized site. Preferred embodiments of the present invention are also directed at validated, outcomes-based, risk-adjusted and peer-controlled methods for measurement and enhancement of the quality of care such as, for example, the quality of surgical care. Further, embodiments of the present invention are directed to the automation of data extraction, data collection, data storage and data analysis methods.

Preferred embodiments of the present invention are utilized to improve, for example, health care, education and research. Different organizations can seamlessly integrate their digital and/or analog information resources with relevant information obtained from external sources in accordance with a preferred embodiment of the present invention. The embodiments of the present invention assure greater reliability of data collection in measuring, for example, surgical performance throughout the nation, lower the cost of participating in the centralized storage of data, and benefit from higher volume of data. The systems and methods in accordance with a preferred embodiment of the present invention facilitate the continuous improvement of surgical care, for example, foster collaboration and information exchange among facilities, provide data repository for research to generate evidence-based findings, and disseminate information.

The foregoing and other features and advantages of the systems and methods to collect, store, analyze, report and present data will be apparent from the following more particular description of preferred embodiments of the system and method as illustrated in the accompanying drawings in which like reference characters refer to the same parts throughout the different views.

### BRIEF DESCRIPTION OF THE DRAWINGS

FIG. 1 illustrates a method for collecting and analyzing patient data in accordance with aspects and embodiments of the invention;

FIGS. 2A and 2B illustrate schematic representations of a system for collecting, transmitting and processing patient data in accordance with an embodiment of the invention;

FIG. 3A illustrates a method for interacting with a local site using a work management station;

FIG. 3B illustrates the method of FIG. 3A in greater detail;

FIG. 4A illustrates an exemplary database structure that can be used for entering and retrieving patient data using a work management station;

FIGS. 4B-4E illustrate exemplary graphical user interfaces that are useful for accepting patient data and for displaying data to an operator using a work management station;

FIG. 5 illustrates a schematic representation of an embodiment of a data automation module containing a submit client, a web data extractor, a customized connector, a database to XML converter and a data blinder;

FIG. 6 illustrates a flowchart showing an exemplary method for implementing a submit client;

FIG. 7 illustrates an exemplary method for implementing a web data extractor in accordance with an embodiment of the invention;

FIG. 8 illustrates a method for blinding data in accordance with an aspect of the invention;

FIG. 9A illustrates a method for joining data at local and central sites using an encrypted ID;

FIG. 9B illustrates an exemplary patient file showing blinded fields;

FIG. 10A illustrates a top level method for performing statistical analyses on patient data;

FIG. 10B illustrates an exemplary graphical user interface useful for assessing risk data associated with a patient file;

FIGS. 10C and 10D illustrate exemplary methods associated with performing financial analyses on patient risk data;

FIG. 10E illustrates an exemplary user display showing data associated with hernia operations;

FIG. 10F illustrates an exemplary user display showing actual mortality data and predicted mortality data;

FIG. 10G illustrates an exemplary method for creating and using monitor objects in accordance with an embodiment of the invention;

FIGS. 10H-10K illustrate exemplary reports produced using an embodiment of a care monitor;

FIG. 11 illustrates an exemplary method practiced on a central site for acquiring and processing data;

FIG. 12A illustrates an exemplary method for implementing a feedback processor;

FIG. 12B illustrates an exemplary user interface for inputting data for performing regression analysis and prediction;

FIGS. 13A and 13B illustrate exemplary methods for implementing an internet interface in accordance with an embodiment of the invention;

FIG. 14 illustrates an exemplary traffic monitor consistent with aspects of the invention;

FIG. 15 illustrates a method for performing data scrubbing consistent with aspects of the invention;

FIG. 16 illustrates a method for performing data export consistent with an embodiment of the invention;

FIGS. 17A-17C illustrate exemplary 8-day reports and weekly site accrual reports, respectively;

FIGS. 17D-17E illustrate methods for performing weekly monitoring;

FIG. 18A illustrates a flow chart showing a method for performing inter rater reliability measurements;

FIGS. 18B-18C illustrate flow charts showing an exemplary training case along with a method for testing a trainee, respectively;

FIG. 19 illustrates a flow chart showing a method for implementing customized field processing;

### DETAILED DESCRIPTION OF THE INVENTION

The systems and methods to collect, store, analyze, report and present data, such as, for example, surgical data includes information workflow and supporting subsystem infrastructures that can be used at medical centers or any facility requiring integration of data. The embodiments of the present invention include interface protocols for data exchange between facilities and a centralized site. Preferred embodiments of the present invention are also directed at validated, outcomes-based, risk-adjusted and peer-controlled methods for measurement and enhancement of the quality of care such as, for example, the quality of surgical care. Further, embodiments of the present invention are directed to the automation of data extraction, data collection, data storage and data analysis methods.

Preferred embodiments of the present invention are utilized to improve, for example, health care, education and research. Different organizations can seamlessly integrate their digital and/or analog information resources with relevant information obtained from external sources in accordance with a preferred embodiment of the present invention. The embodiments of the present invention assure greater reliability of data collection in measuring, for example, surgical performance throughout the nation, lower the cost of participating in the centralized storage of data, and benefit from higher volume of data. The systems and methods in accordance with a preferred embodiment of the present invention facilitate the continuous improvement of surgical care, for example, foster collaboration and information exchange among facilities, provide data repository for research to generate evidence-based findings, and disseminate information.

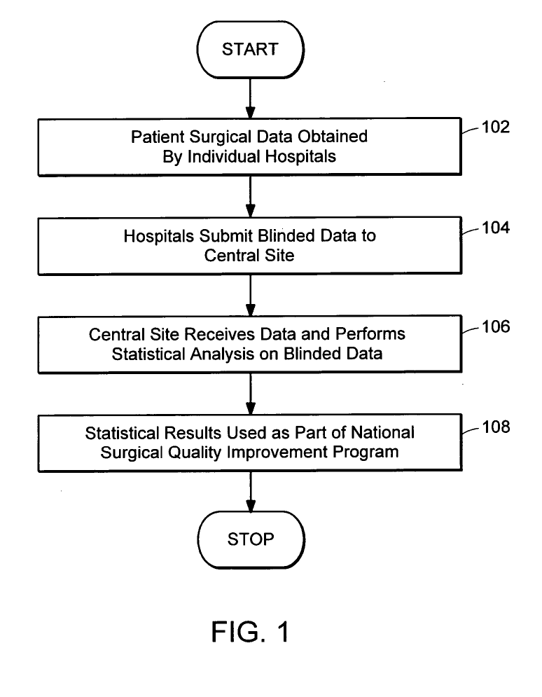

FIG. 1 illustrates a high level method for collecting and processing data associated with patients such as, for example, data associated with surgical procedures. Patient surgical data is collected by participating hospitals from treated patients (step 102). Participating hospitals modify the patient data according to defined procedures so as to produce blind data sets for the respective patients.

A blind data set is one where parameters associated with a particular patient remain intact; however, data uniquely identifying that patient is removed or encrypted in a manner so as to prevent identification of the particular person from whom the data was obtained. For example, a patient's name, address, phone number, insurance information and social security number may be removed from a file containing that patient's vital signs, surgical procedure performed, medications administered, etc. Blind data sets allow meaningful data analyses to be performed while protecting the identities of the individuals from whom the data was obtained.

Hospitals submit blind data sets to a central site (step 104). A central site as used herein, refers to a location where data collected from a plurality of hospitals is retained and analyzed. The central site receives the blind data sets and performs statistical analyses thereon (step 106). The statistical results are then used for making determinations with respect to data gathered on a national level such as for use in the National Surgical Quality Improvement Program (NSQIP) (step 108). Details of the hardware and software necessary for implementing an embodiment for performing this data collection and analysis are provided hereinbelow.

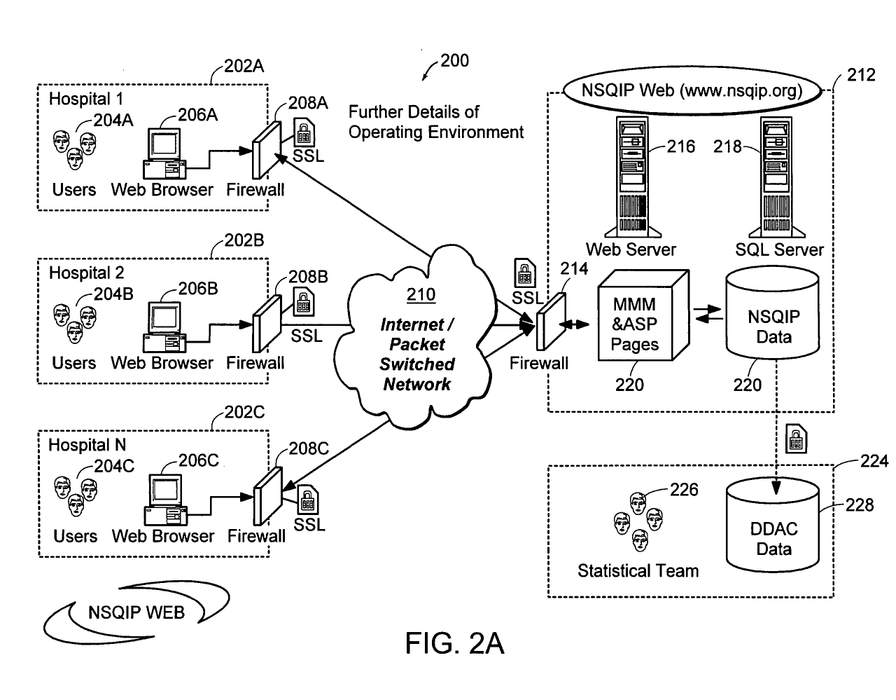

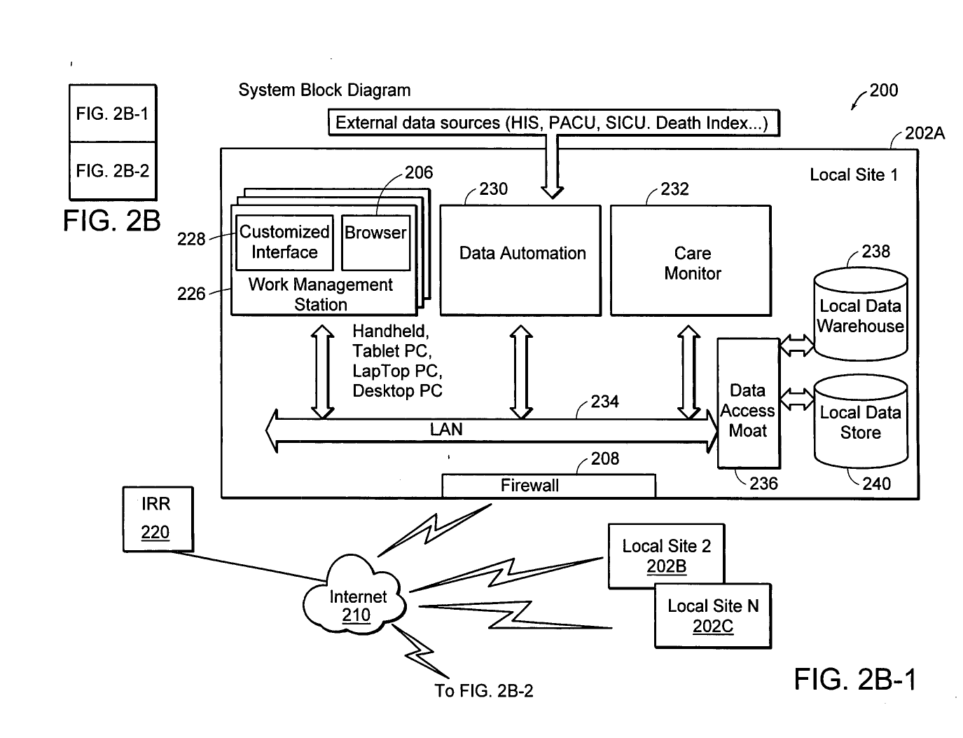

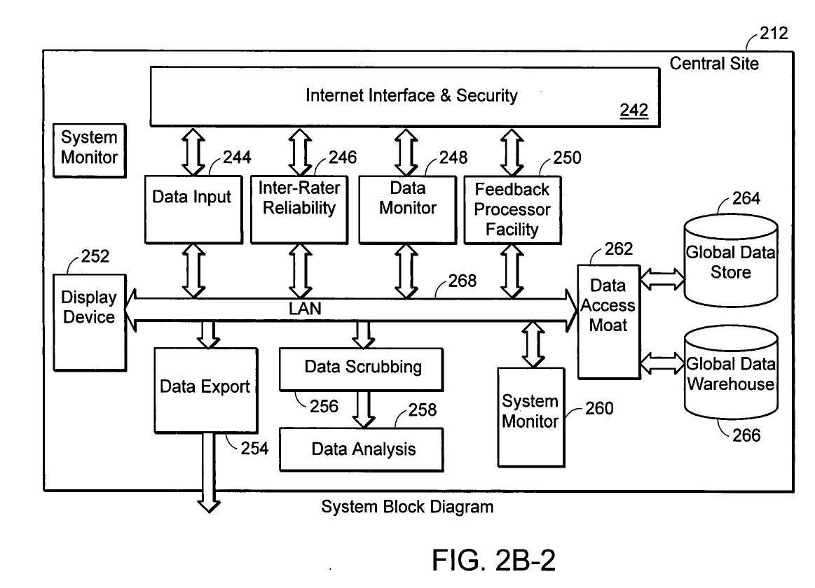

FIG. 2A illustrates a schematic representation of a system 200 for practicing the method of FIG. 1. System 200 may include a plurality of local sites, or hospitals, 202A-C each having a plurality of users 204A-C, a web browser 206A-C, and a firewall 208A-C; a data communications wide area network (WAN) 210 such as the Internet; a central site 212 having a firewall 214, a web server 216, an SQL server 218, hypertext markup language (HTML) and application service provider (ASP) pages 220, an NSQIP database 222, and connected to an analysis facility 224 having a statistical team 226 and DDAC data 228.

FIG. 2B illustrates the elements of FIG. 2A in more detail. Local sites 202A-C, herein generally referred to as local site 202, may include a work management station 226, a customized interface 228, browser 206, a data automation module 230, a call module 232, a local area network (LAN) 234, a data access moat 236, a local data warehouse 238, a local data store 240 and firewall 208. Local site 202 stores data acquired from its patients in local data store 240. Work management station 226 is used to enter patient data via a keyboard using browser 206 or using customized interface 228. Work management station 226 may include, among other things, a nurses workstation, an administrators workstation, a medical technician's workstation, etc. Data automation module 230 may interact with external databases such as, for example, PACU, SICU, or HIS or a death index to extract and store relevant data in local data store 240. Data automation module 230 may employ rule based techniques and methods for extracting data from the external databases or from work management station 226. Care monitor 232 is used to display real-time or quasi-real time patient information in conjunction with local data store 240. Local data warehouse 238 is used for non real-time data transactions such as for performing cost analysis of surgical operations using large amounts of data. Data access moat 236 controls access privileges for users of local site 202. The modules making up local site 202 may be coupled using a LAN 234 or using a bus. Firewall 208 is used for coupling local site 202 to WAN 210. Firewall 208 may run security protocols and/or screen incoming and outgoing data for malicious code such as computer worms or viruses. Work management station 226 can be used by an operator such as a nurse, for manually inputting patient data or it can be operated in an automated manner.

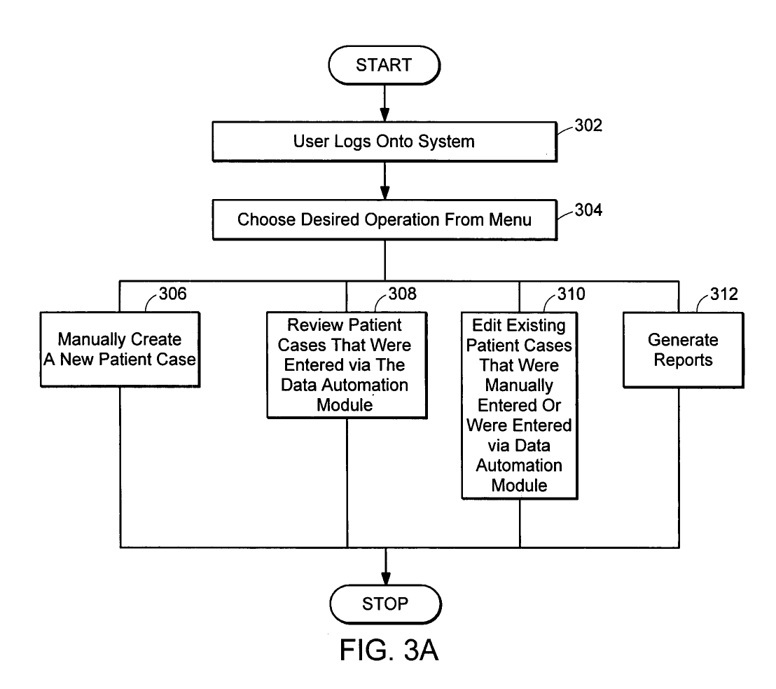

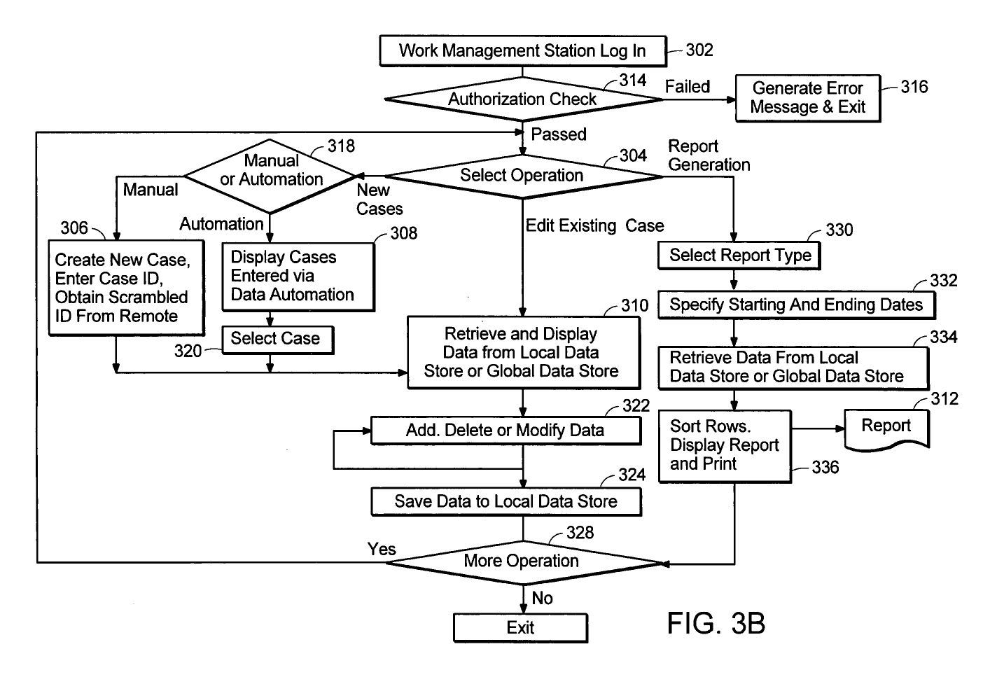

FIG. 3A illustrates a top level method for interacting with local site 202 using work management station 226. The method begins when an operator logs onto the system by correctly entering authorization data such as a user name and password (step 302). Next the operator selects a desired operation from a menu of available operations (step 304). The operator may choose to manually create a new patient case using a keyboard or other input device (step 306). Alternatively, the operator can review patient cases that were previously entered into local site 202 using data automation module 230 (step 308). Or, the operator can edit existing patient cases that were manually entered into local site 202 or that were entered using data automation module 230 (step 210). Or, the operator can generate reports (step 312).

FIG. 3B provides a more detailed illustration of the method shown in FIG. 3A.

After logging in (step 302) the operator's identity is checked using known methods (step 314). If the authorization is successful, the operator selects a menu option (step 304). In contrast, if the authorization failed, an error message is generated and the operator is dropped from the system (step 316). If the operator selects manual or automation (step 318), they may be allowed to create a new case ID (step 306) or they may display cases entered using data automation (step 308).

If cases are created manually, the operator may have to enter information such as patient name, address, insurer information, medical record number, etc. In addition, the operator may be prompted to enter a case ID and a patient ID. If prompted for a patient ID, the entered data may be scrambled, or encrypted, using a data blinding algorithm made available by central site 212.

If new cases were created using data automation, data may have been extracted from other systems or applications. The data automation module 230 makes a listing of these cases available to the operator by way of a display device. Table 1 contains an exemplary listing that can be provided to an operator in conjunction with step 308.

TABLE 1
Sample List of New cases from Data Automation

| | | Last | First | | |
|---|---|---|---|---|---|
| Date | MRN | Name | Name | Case No. | Status |
| Jun. 20, 2003 | 276435 | Smith | John | 9783 | Complete |
| Jun. 20, 2003 | 156488 | Lee | Jane | 9031 | Incomplete |
| Jun. 18, 2003 | 233301 | Hunter | Brian | 9022 | error |

In Table 1, the rows may be initially sorted by reverse chronological order. The operator may change the order by performing a single click over, for example, a row or column heading. Double clicking over a row may open the file associated with the entry (step 320). Data from the requested file may be retrieved from the local data store 240 or the global data store 264. When the file is open, the operator may change data associated with fields therein (step 322). The workstation may flag fields that have been changed by the operator so a record is maintained as to what fields have been manually changed. After changing or manipulating data, the file may be saved to local data store 240 or global data store 264 (step 328). A save data routine may determine what data can be sent to global site. At step 304, if the operator selects report generation, the operator is queried to select a report type (step 330). The operator may assign starting and ending dates (step 332). Examples of reports that can be generated are, but are not limited to, aging reports, data collection forms, medical record requests, 30-day patient follow-up letters, and death lists. Data is retrieved from local data store 240 or global data store 264 (step 334). Retrieved data is sorted and displayed or printed (step 336). The operator can also view the final report (step 312). The method of FIG. 3B checks for additional operations (step 328) and if none are present or in a queue, the method ends.

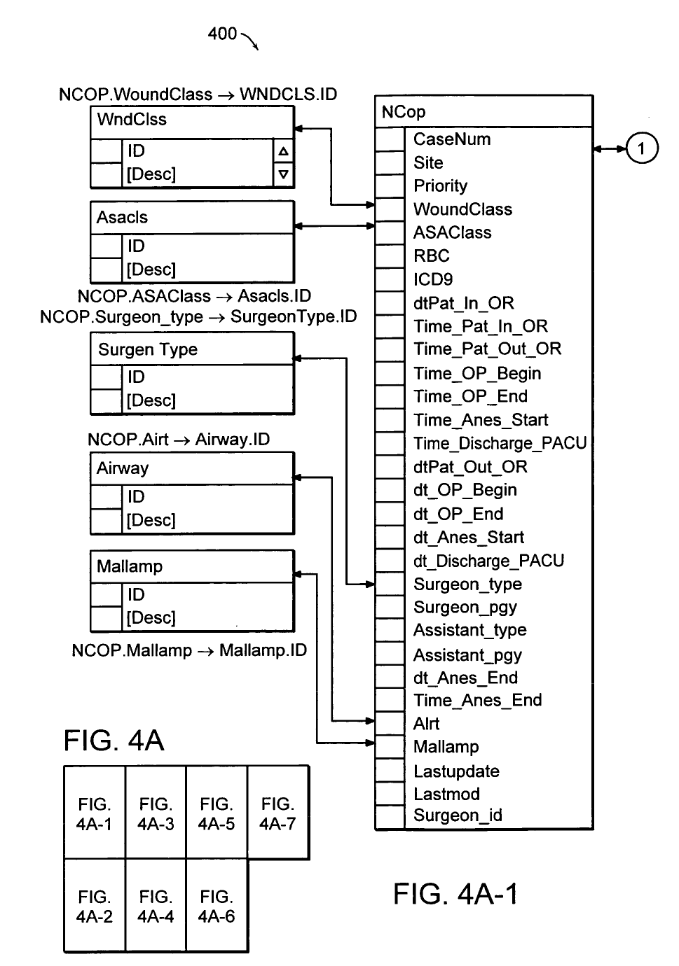

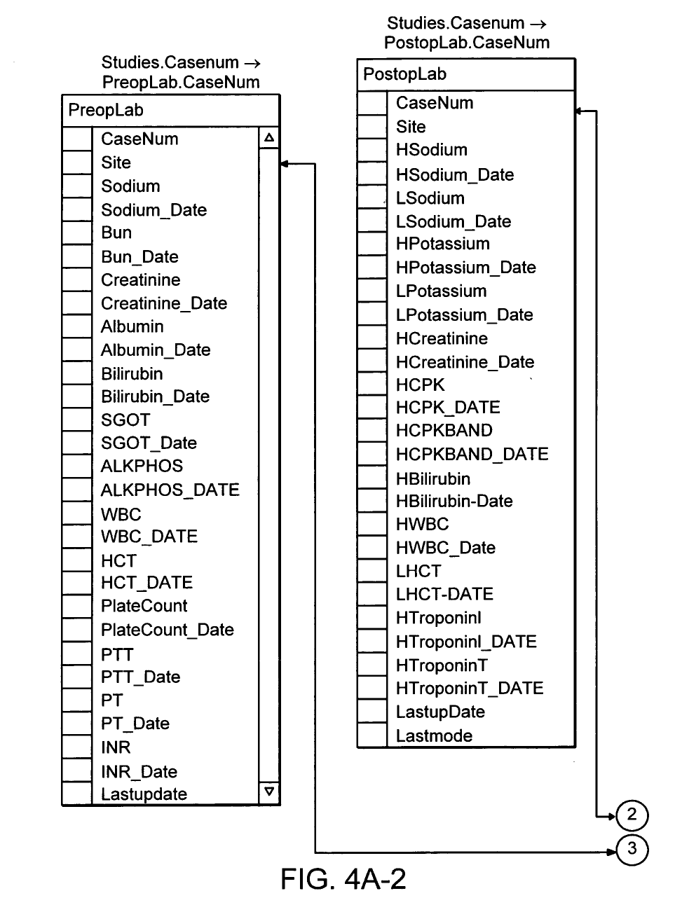

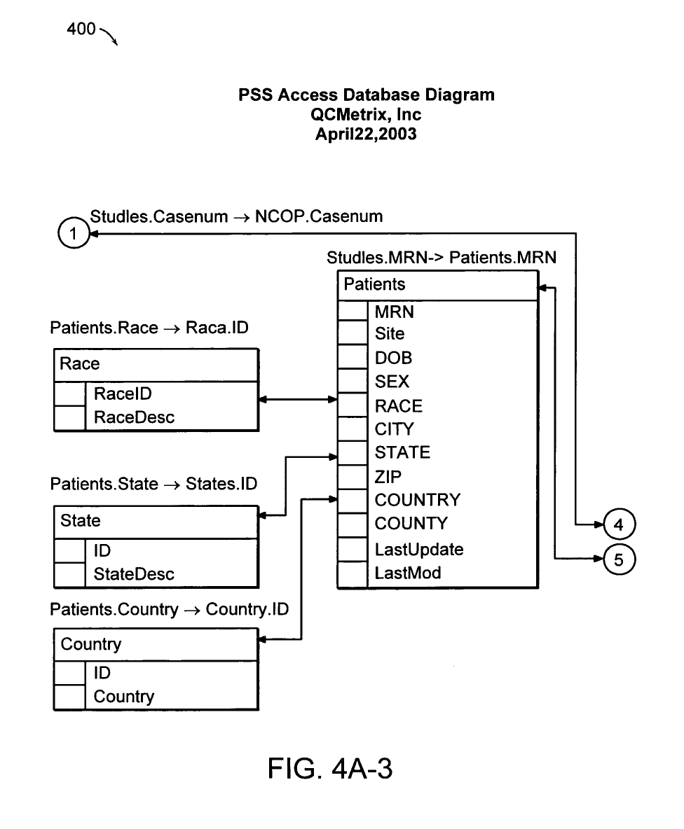

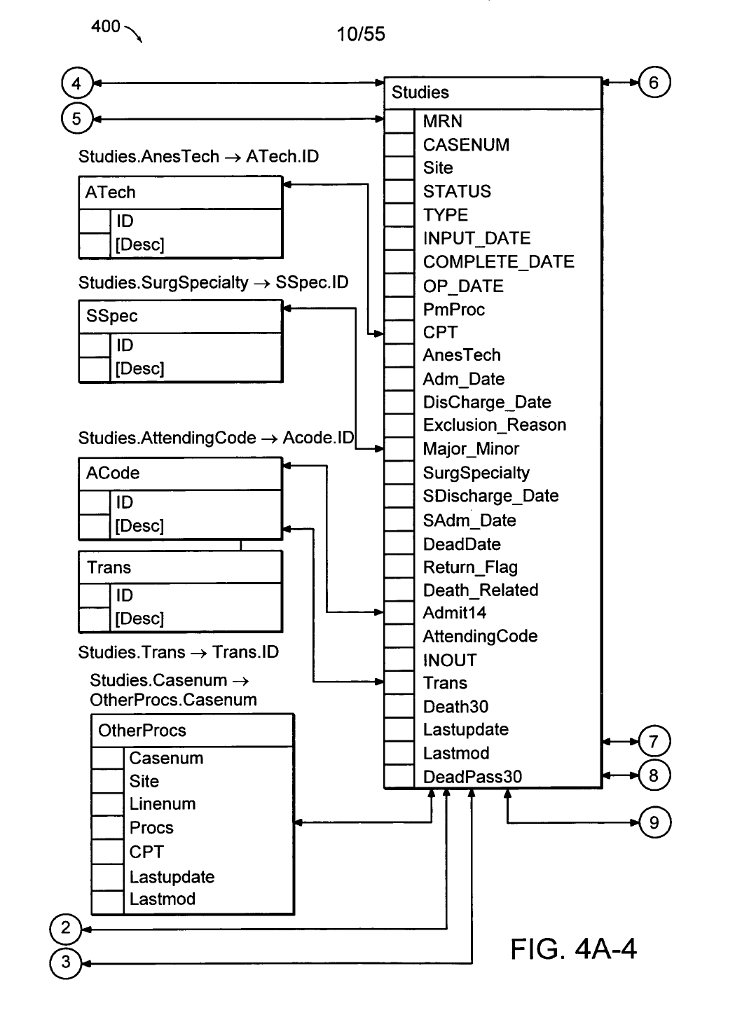

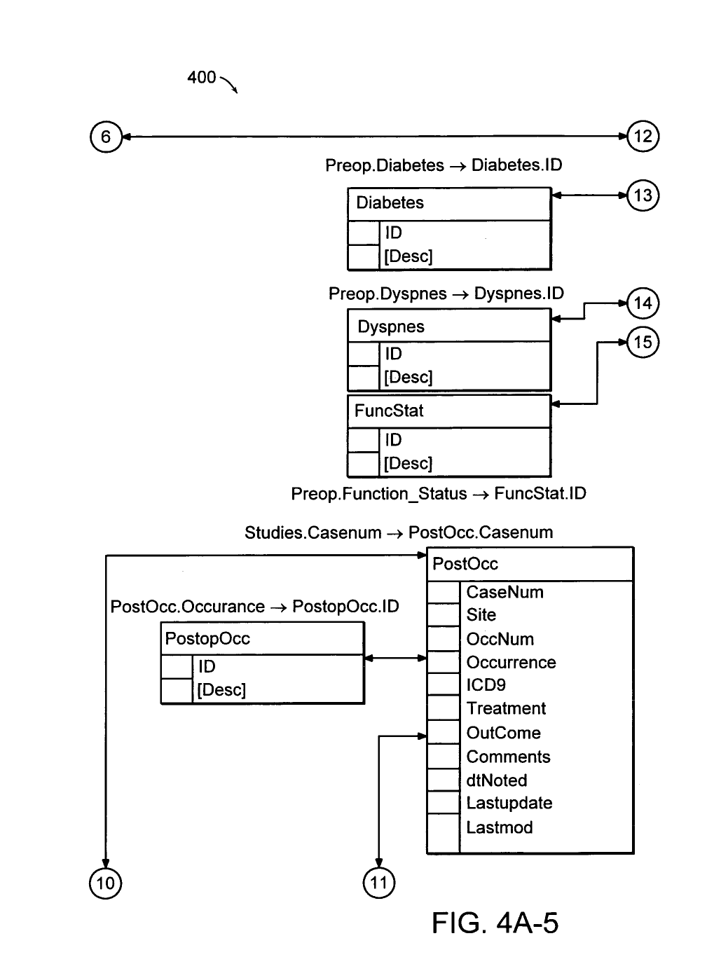

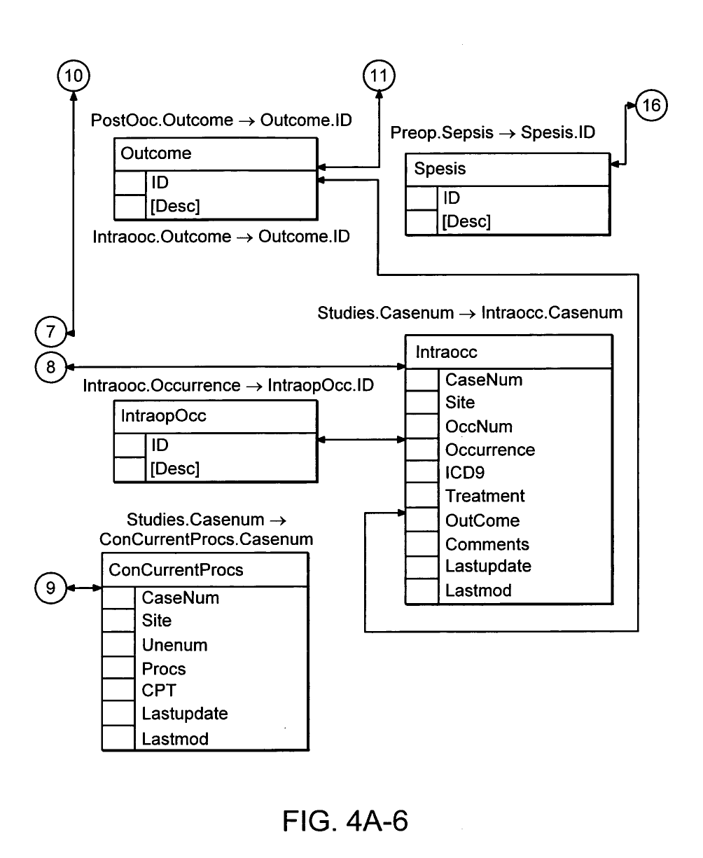

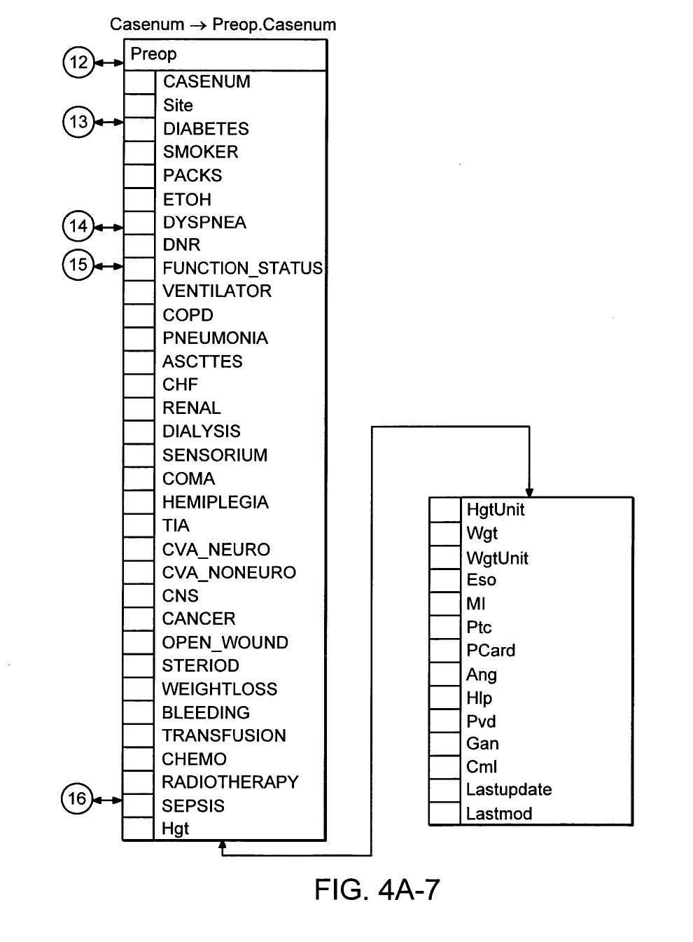

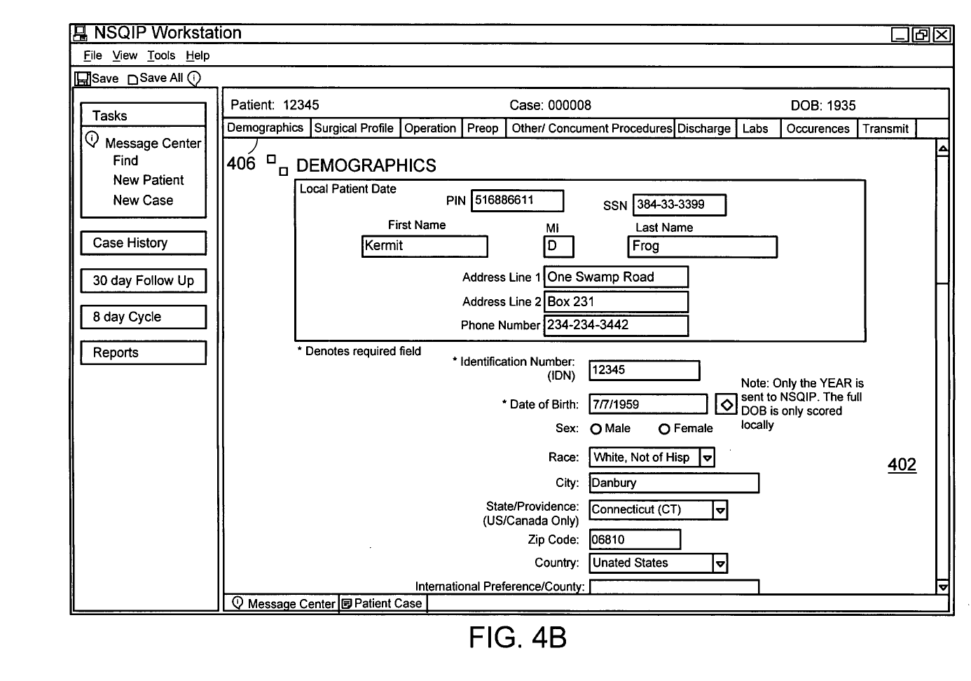

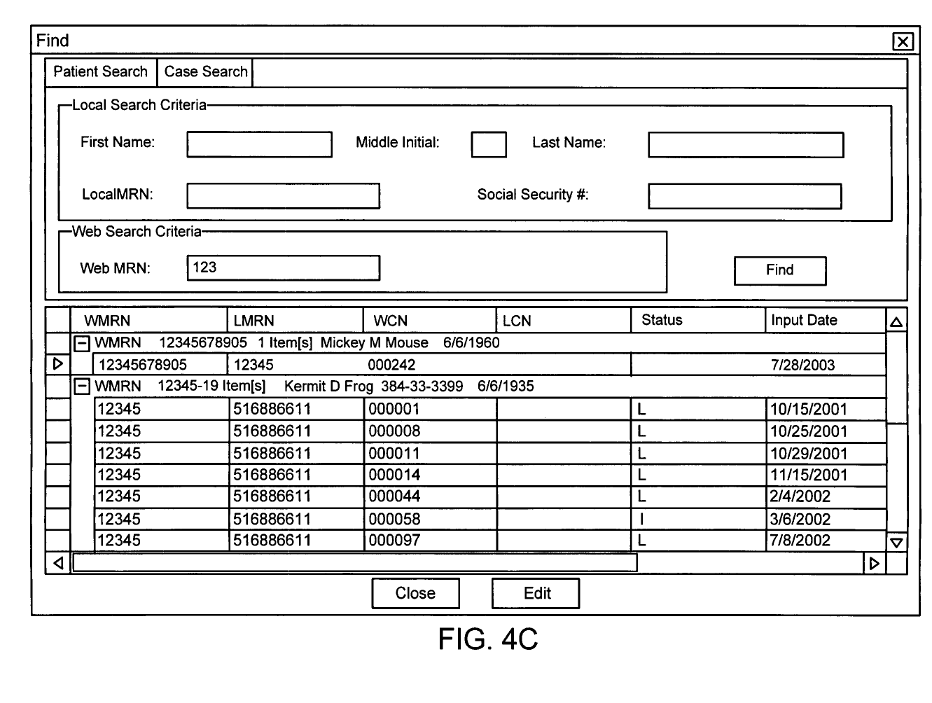

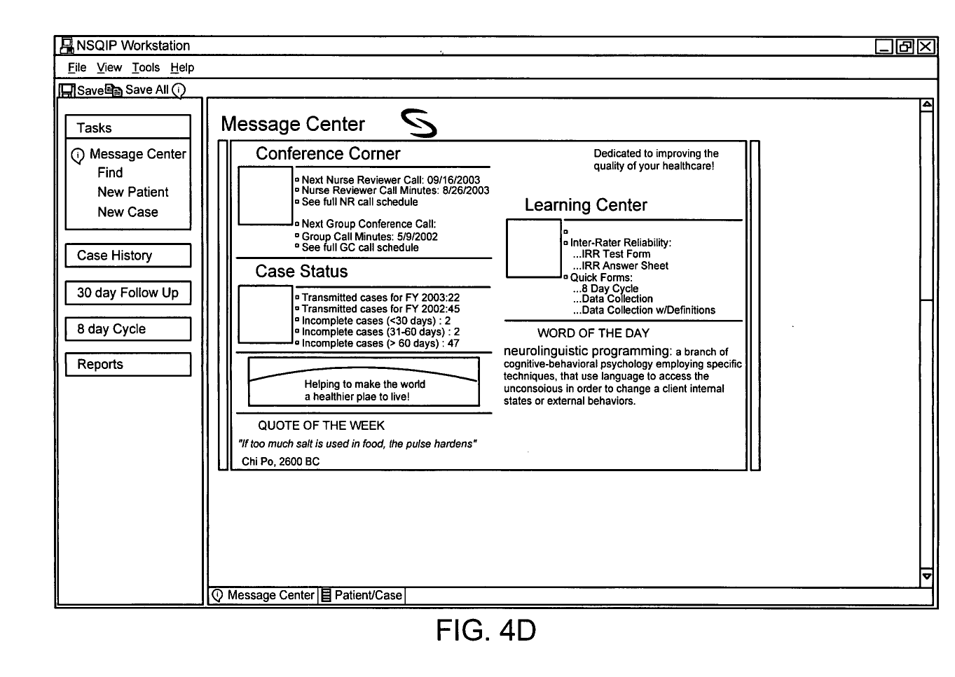

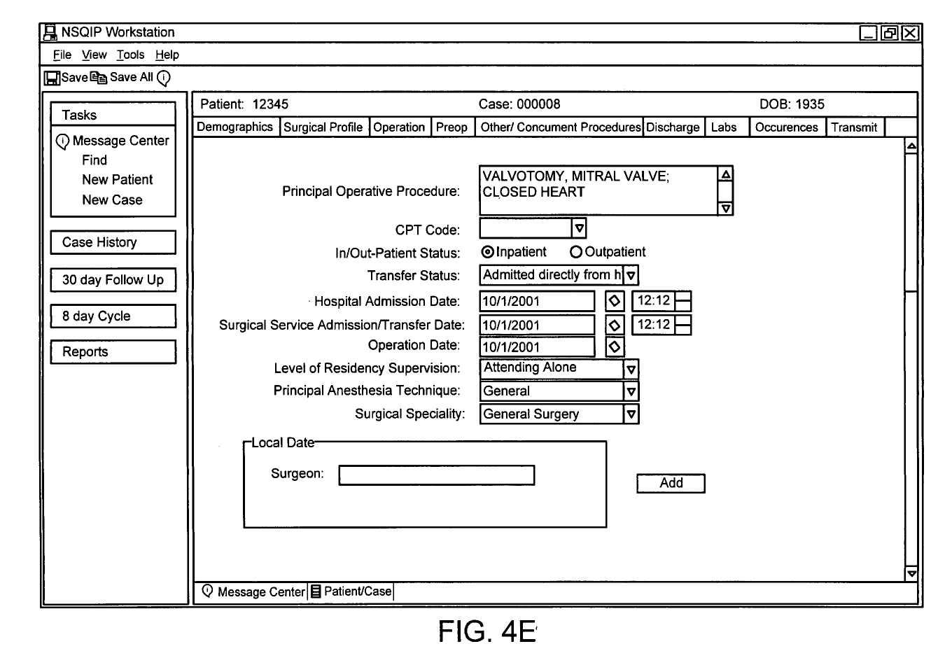

FIG. 4A illustrates a Microsoft Access® database diagram 400 illustrating exemplary fields that can be used in conjunction with work management station 226 for entering patient data manually or automatically by way of data automation module 230.

FIGS. 4B-4E illustrate exemplary graphical user interfaces that can be used by an operator for viewing and entering data into work management station 226. FIG. 4B illustrates a demographics window 402 having a plurality of fields 404 for entering information such as a patient's name, address, date of birth, race, gender, etc. Other windows may be selectable by clicking on a tab 406 using an interactive pointing device such as a mouse of trackball.

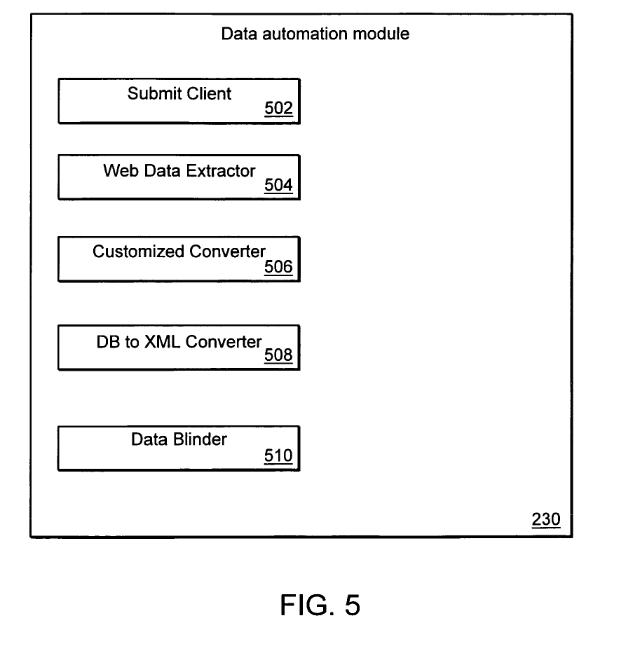

FIG. 5 illustrates a schematic representation of data automation module 230 along with machine-executable modules that can operate therewith. In particular, FIG. 5 illustrates a submit client module 502 that facilitates transmission of data to storage modules operating in conjunction with local site 202 or central site 212. A web data extractor module 504 operates to import data from external web sites. A database to extensible markup language (XML) converter 508 operates to convert data from database compatible formats to XML compatible constructs when needed. A data blinder 510 operates to remove patient specific data from files prior to transmission from local site 202 to central site 212.

Submit client 502 includes an XML-based data submission protocol that allows a local site 202 to store data at both local storage devices and at storage devices associated with central site 212 based on a set of business rules. This protocol is referred to as the catcher's mitt.

For example, local sites 202 such as hospitals may send HIPAA compliant data electronically to the central site and keep other data within the local site. Optionally, the Catcher's Mitt can be used to electronically send data from one hospital to another provided that the receiving hospital is authorized to receive the data and is further running the necessary software.

The Catcher's Mitt is comprised of four distinct components which are an XML Schema, a Java Submit Program, a PIN adapter, and a Loader adapter. These four components utilize various technologies and products including Attunity Connect, Xerces and Xalan from Apache.org and JDOM from jdom.org. Attunity Connect is a data and application access middleware product which provides access to data and applications through standard based application programming interfaces (API's) including JDBC, JCA, XML, ODBC, OLEDB, COM, etc.

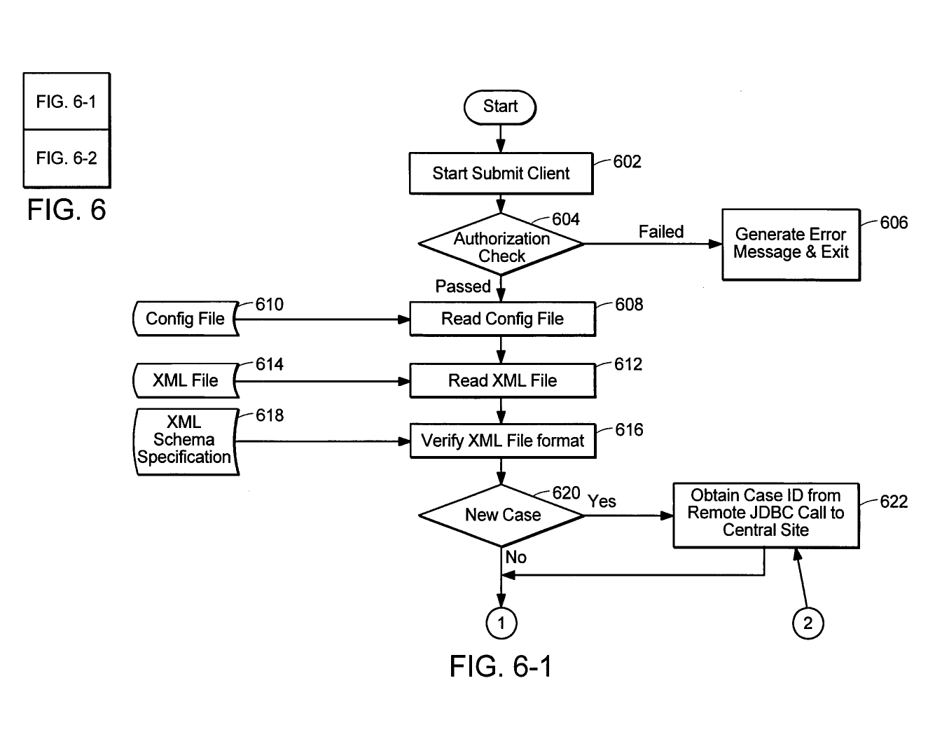

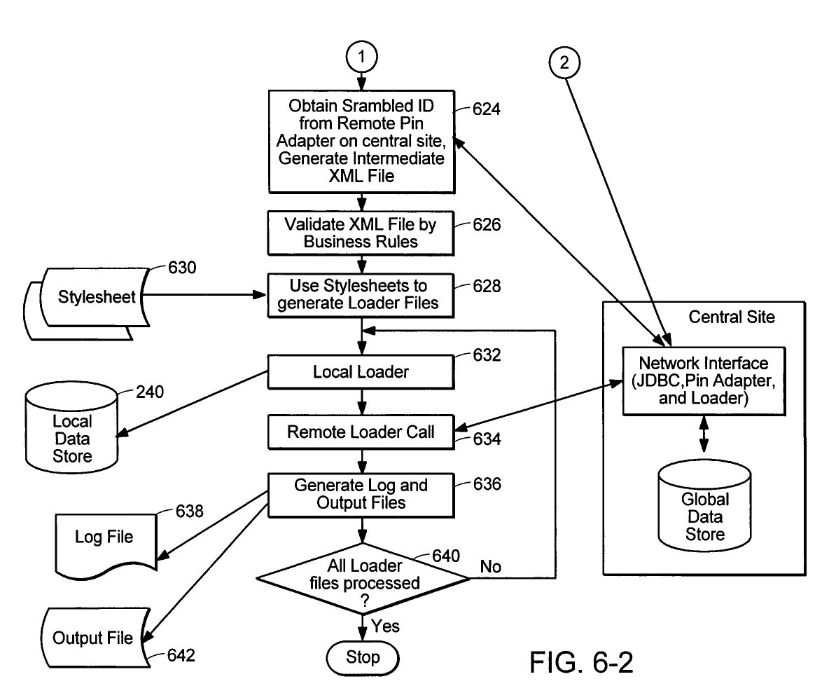

FIG. 6 illustrates a method for implementing submit client 502 in accordance with exemplary embodiments. The method begins when submit client 502 is activated on local site 202 (step 602). An authorization check is performed to validate an operator (step 604). If the authorization fails, an error message is generated and the operator is disconnected (step 606). In contrast, if the authorization is successful, a configuration file 610 is read (step 608). In a preferred embodiment, configuration file 610 is XML based. Additional information may be read via one or more XML files 614 (step 612) from, for example, central site 212 via JDBC. This data can be combined with local data to define a configuration for a current session on local site 202. If conflicts between local and remote data should arise, an overwrite priority can be specified.

After the XML document is loaded in step 612, an XML schema 618 is used to verify the basic compliance of the file format (step 616). Next, a query is made to determine if a new case is identified, a case ID may be obtained from central site 212 using a remote JDBC call (step 622). In an embodiment, central site maintains a counter indicative of case numbers. When local site 202 requests a case number, the counter is incremented to the next ID value. The loaded XML document is updated by way of internal fields to facilitate the loading process. In addition, a remote PIN adapter provides a scrambled ID (step 624). Central site 212 may provide the PIN adapter using JCA. In an embodiment a medical record number (MRN) may be scrambled.

The XML document may then be validated using one or more defined business rules (step 626). If an XML file, or document, contains multiple case studies, it ay be broken into smaller documents with the number of studies per document based on a configuration setting. The XML document is then transformed into a format compatible with a loader running on the local site 202 (step 632) in conjunction with local data store 240. In addition, a format compatible with a remote loader running on central site 212 can be generated (step 634). On local site 202, a transformed document may be sent to the local loader using a basic socket call and any response can be parsed and checked for errors.

A log file 638 and/or an output file 642 may be generated (step 636). Next, a determination may be made to determine if all loader files have been processed (step 640). If all loader files have been processed, the method ends. In contrast, if all loader files have not been processed, the method loops back to the input of step 632.

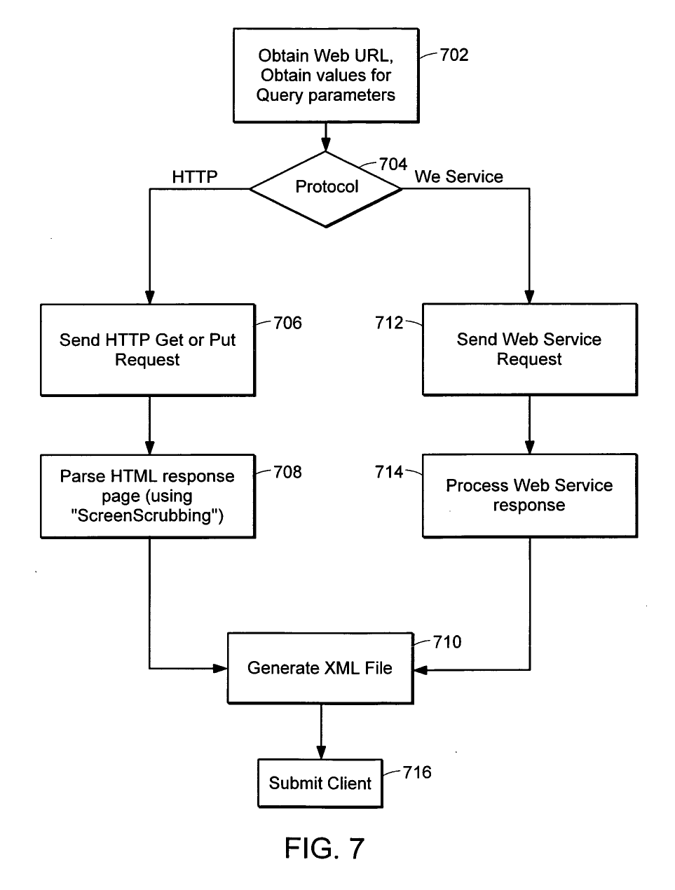

Web data extractor 504 is used to import data contained in external web sites. In preferred embodiments, web data extractor can be implemented using the Microsoft.Net platform. FIG. 7 illustrates an exemplary method for implementing web data extractor 504. The method of FIG. 7 begins with obtaining a web universal resource locator (URL) along with values for query parameters (step 702). Next, a check is made to determine what type of protocol is being run (step 704). If a hypertext transport protocol (HTTP) is running, an HTTP get or put request is sent (step 706). Then an HTML response page is parsed using screen scrubbing techniques relying on knowledge about the exact position of answers, or information, in the HTML response page.

At step 704, if a web service protocol is identified, a web service request is sent (step 712). Then a web service response is processed (step 714). After step 708 or 714, an XML file is generated (step 710). The web data extractor 504 combines the extracted data with internal data to generate an XML file based on the catcher's mitt schema specification.

Data blinder 510 operates to encrypt patient identifying information associated with files transferred from local site 202 to central site 212. In many applications, such as in the NSQIP application, the central site is not allowed to store data elements that may identify the data records back to the corresponding real entity (e.g. a patient). For instance, the central site is not allowed to store a patient's name or social security number, or medical record number because all such data elements can link a data record back to a patient violating patient confidentiality regulations HIPAA. By using site configuration files to specify business rules which are used in the system, one may eliminate all such data elements from being stored improperly. On the other hand, it is still necessary to provide a mechanism so that users with the proper authorities and permissions may create/delete/modify/retrieve data records for specific patients based on a patient's real identity. This mechanism is known as “data blinding”.

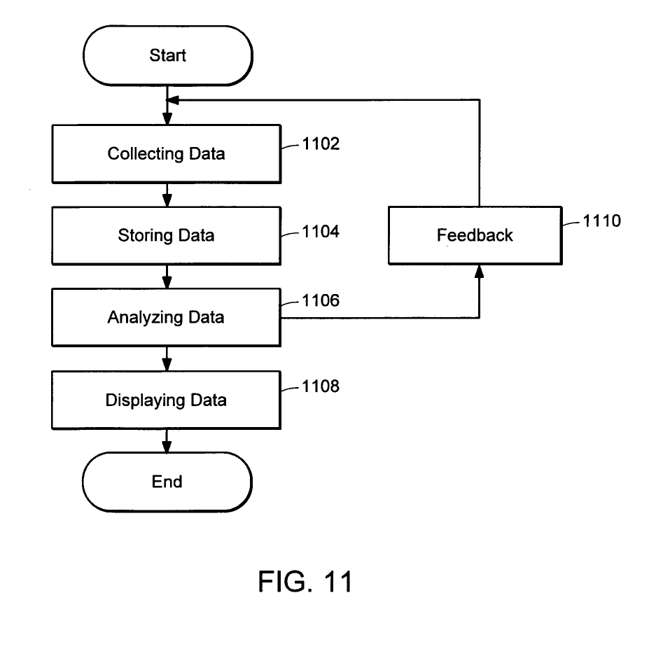

Each case (i.e. a patient data record) in the system is identified by a key which is the encrypted form of the real ID of the corresponding person. The encrypted key is derived from a site PIN (Personal Identification Number) and the real patient ID. Although the system performs the encryption, the PIN is supplied by a user at time of the encryption and the PIN is erased from the system memory afterwards. Even though the encrypted keys are visible and used by users with lower level of authorization, the encrypted keys can only be unscrambled by a user with the PIN. The data blinding process is illustrated in FIG. 11A.

While the central site is free of identification-sensitive data elements, the local sites are not restricted and indeed contain these elements. (For instance, in the hospital environment, the work management station can produce the 30-day follow-up list, which is a list of patient names, medical record numbers, and dates of operation.) In fact, the real patient ID is stored together with the encrypted ID. In situations where the combined data from both the central and local sites are retrieved, the encrypted ID is the only linkage between the two sets of data records. It is cumbersome to require users to work with two distinct forms of IDs that identify the same data records. The system is implemented with the flexibility to accept the real ID when data is entered from a module on the local component with the exception of the browser. At the time of data entry, the real ID is immediately scrambled to obtain the encrypted one and from then on, the encrypted id is used in all subsequent operations. This process is illustrated in FIG. 11B.

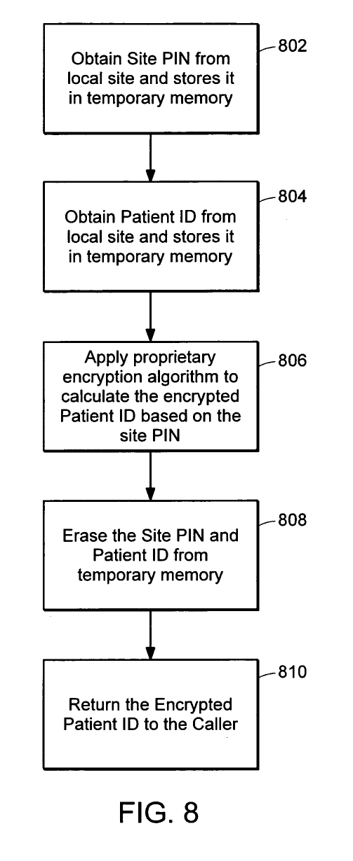

FIG. 8 illustrates a method for implementing data blinding in a preferred embodiment. A site PIN is obtained from the local site 202 and stored in temporary memory (step. 802). A patient ID is then obtained from the local site and further stored in temporary memory (step 804). An encryption algorithm is applied to calculate an encrypted patient ID based on the site PIN (step 806). Next, the patient ID and site PIN are erased from temporary memory (step 808). Then the encrypted patient ID is returned to the requester (step 810).

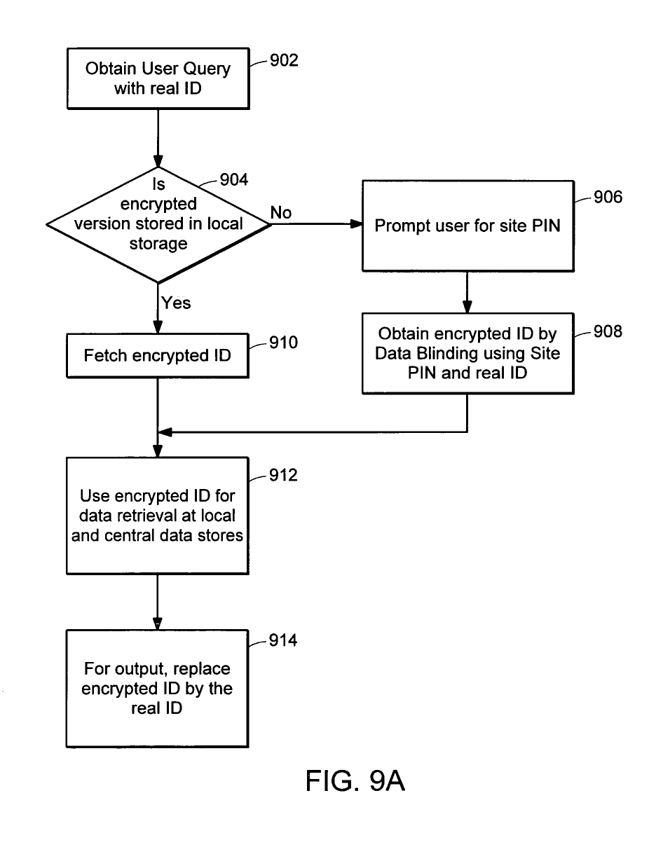

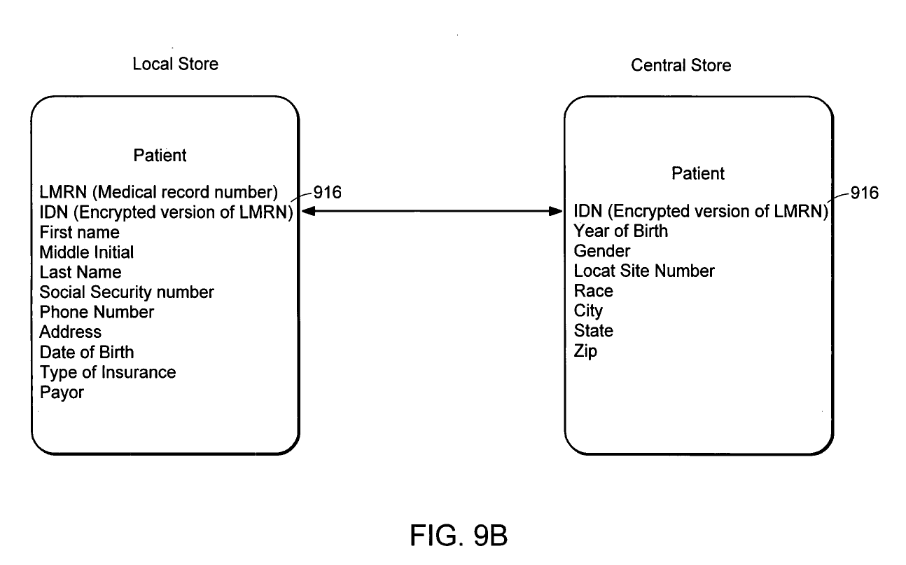

FIG. 9A illustrates a method for joining data at a local site 202 and a central site 212 using an encrypted ID. A user query is obtained by way of an ID identifying the user (step 902). Next a query determines whether the encrypted version is stored in local storage (step 904). If the encrypted version is stored in local storage, the encrypted ID is fetched (step 910). In contrast, if the encrypted version is not stored in local storage, the user is prompted for a site PIN (step 906). Then the site PIN and user's real ID are used by data blinder 510 to produce an encrypted ID (step 908). The encrypted ID is used for data retrieval at local and central data stores (step 912). The encrypted ID is replaced with the real ID for output (step 914).

FIG. 9B illustrates an exemplary patient record that has an encrypted identification field 916. The encrypted field 916 prevents the patient file on central site from being associated with the particular individual whose personal information is in the file.

Care monitor 232 handles resource scheduling procedures based upon predicted usage patterns of the resources. The call monitor 232 employs a predictive function to produce an estimated value. This estimated value is fed to a scheduler for reservation and allocation. Use of care monitor 232 allows operators, such as nurses to make informed decisions with respect to resources.

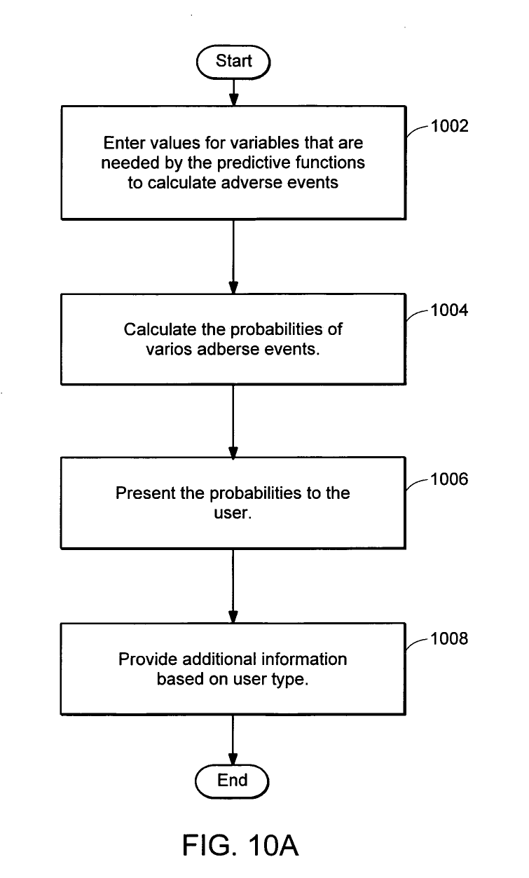

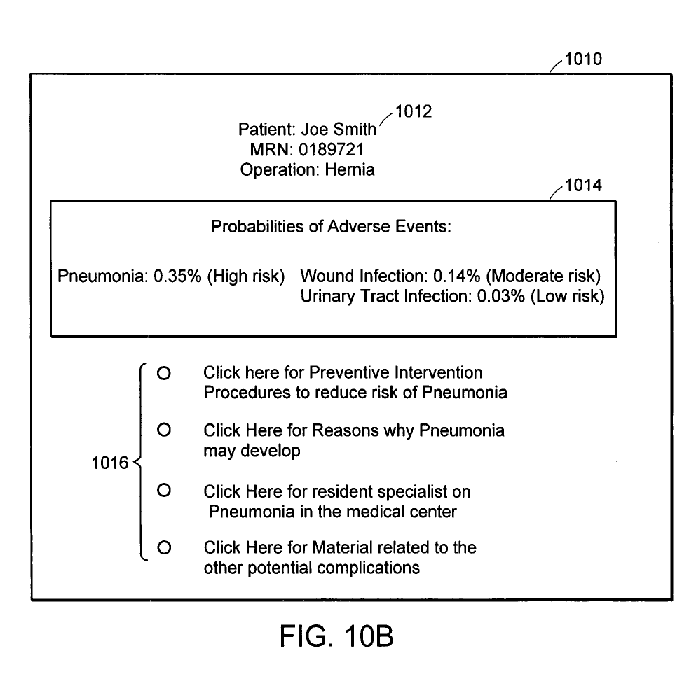

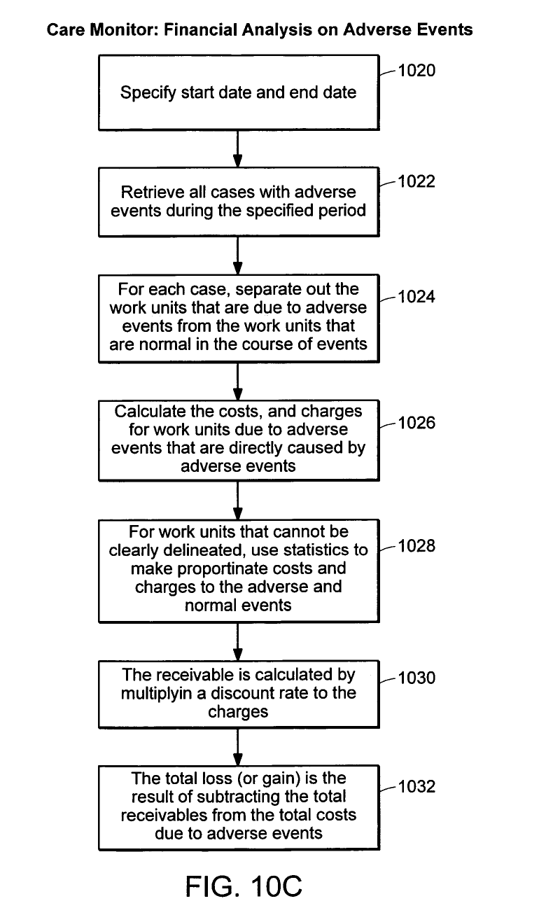

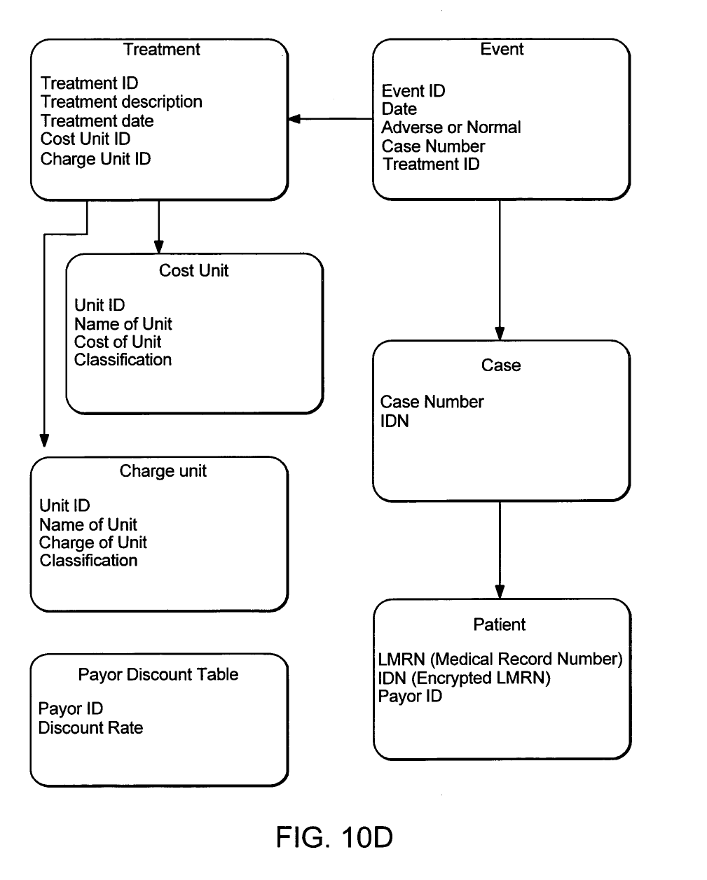

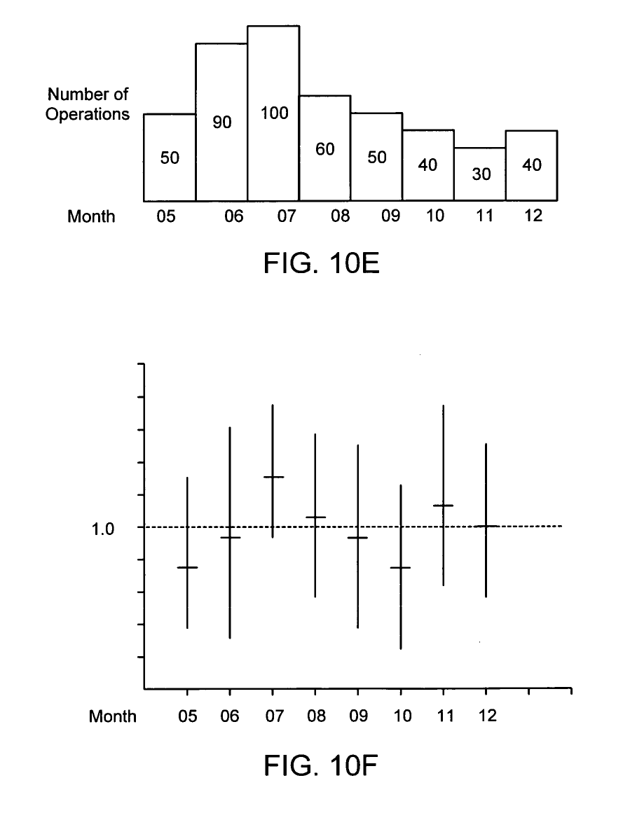

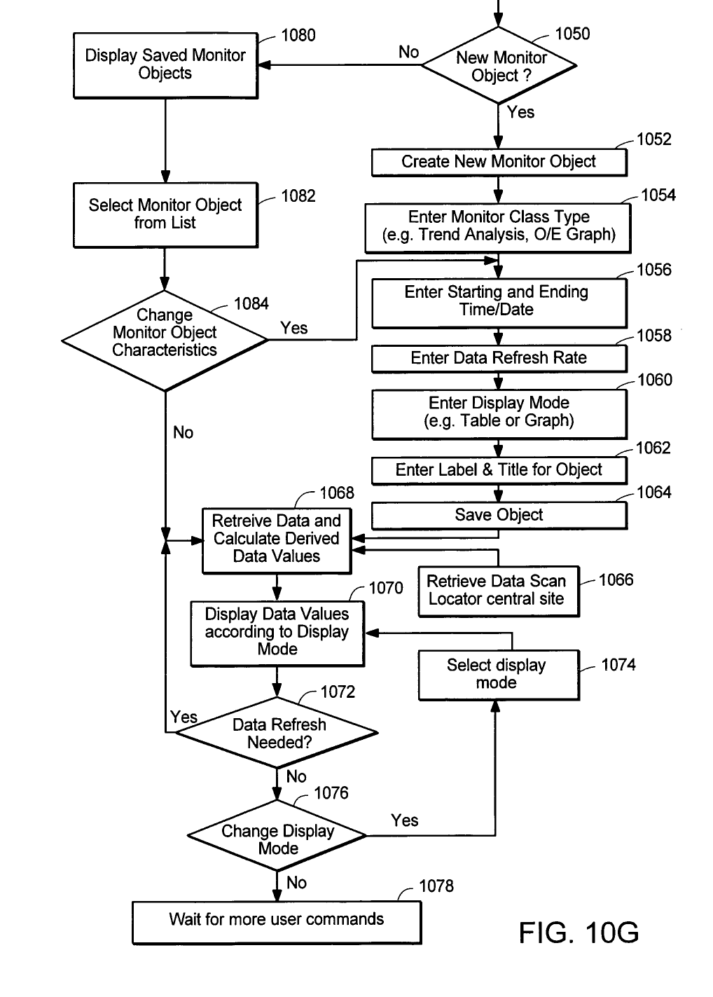

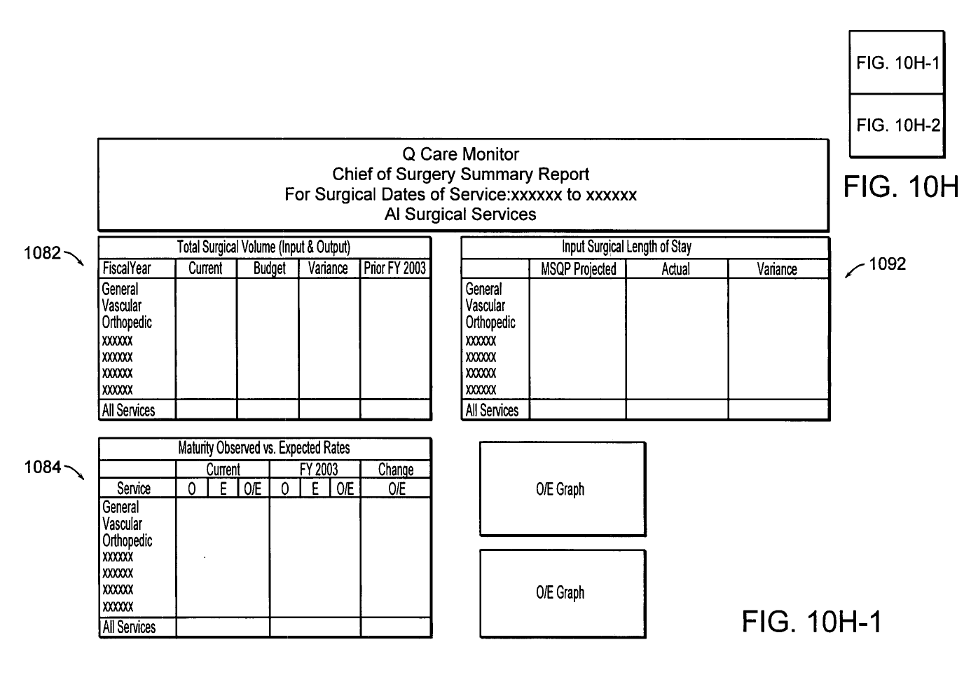

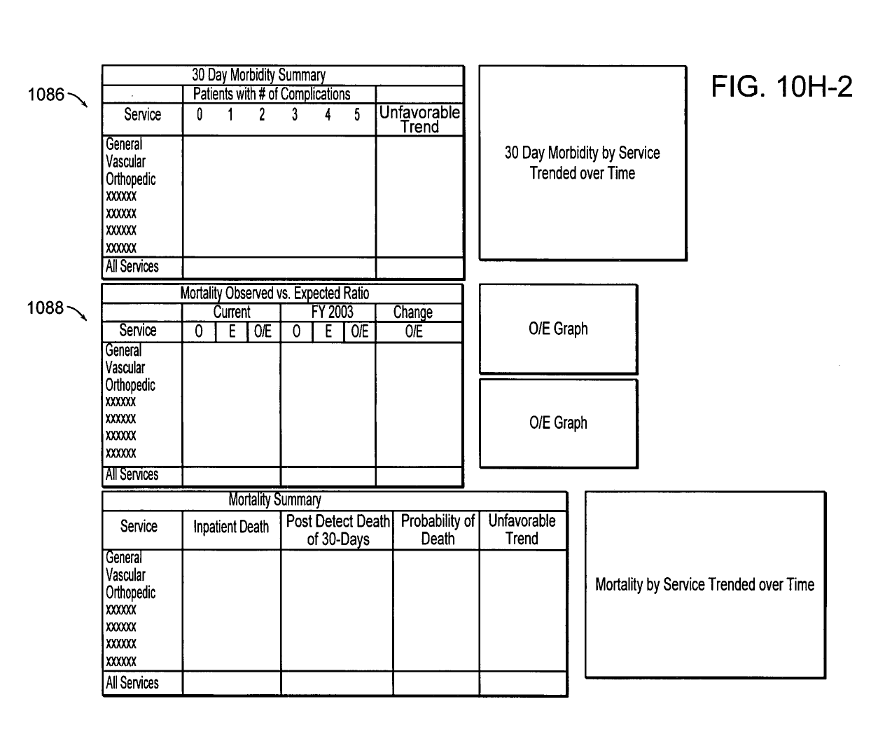

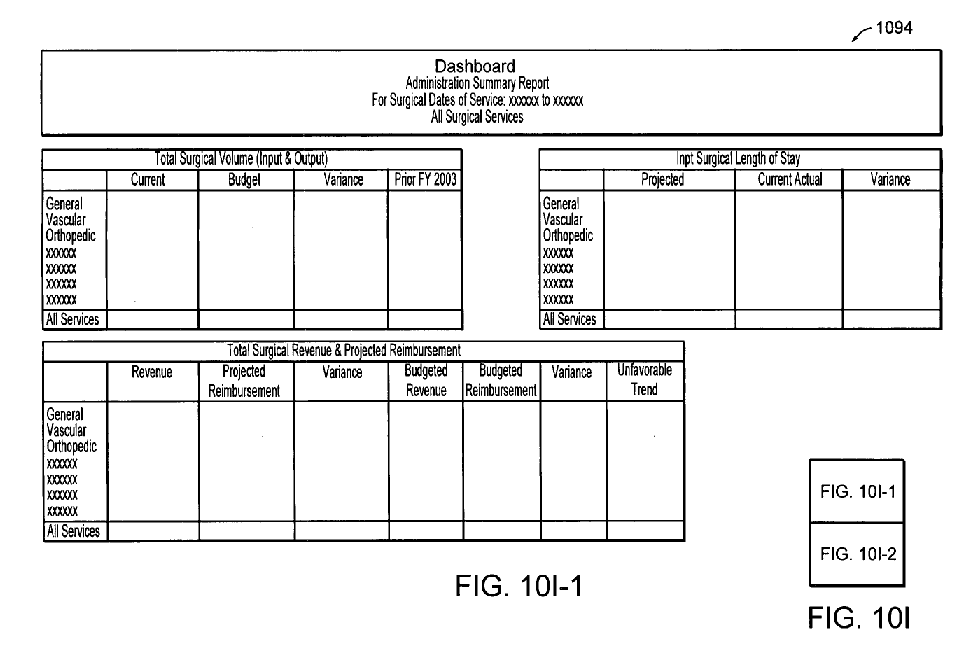

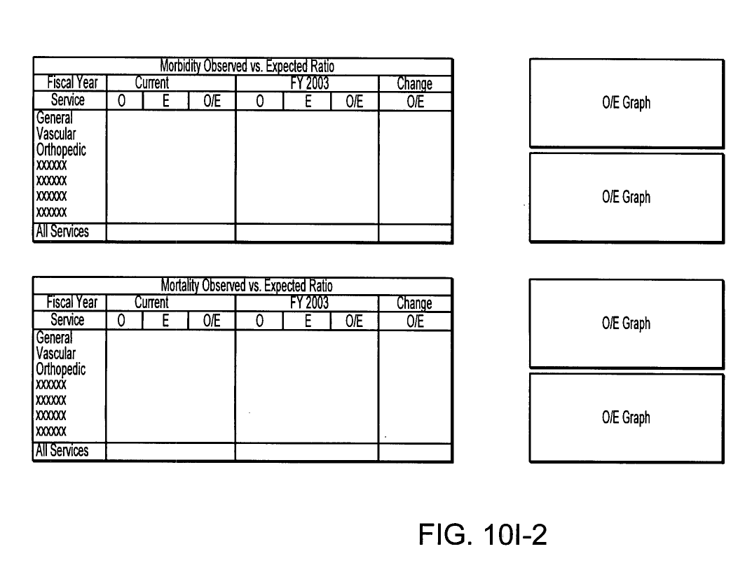

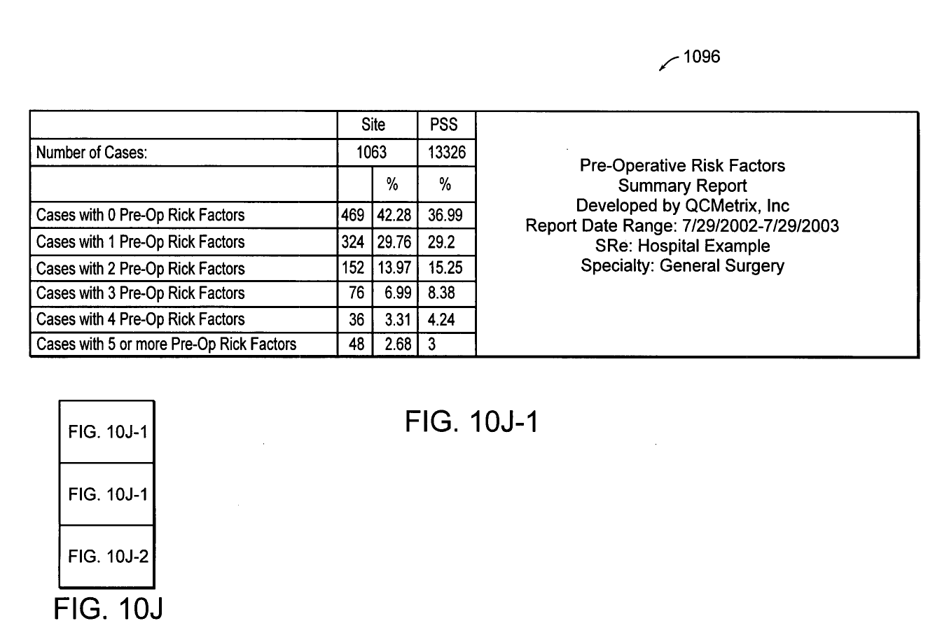

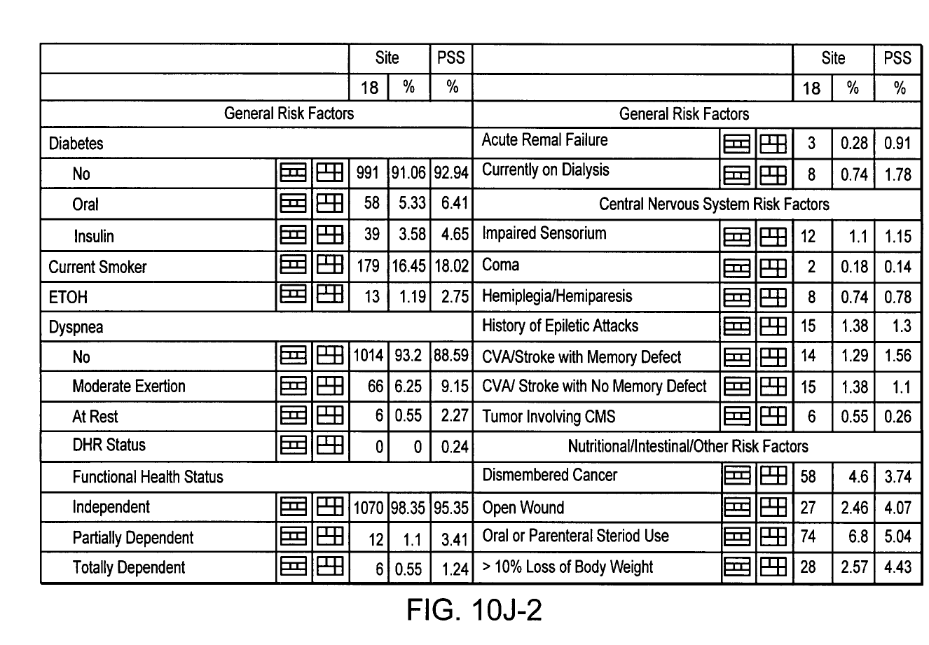

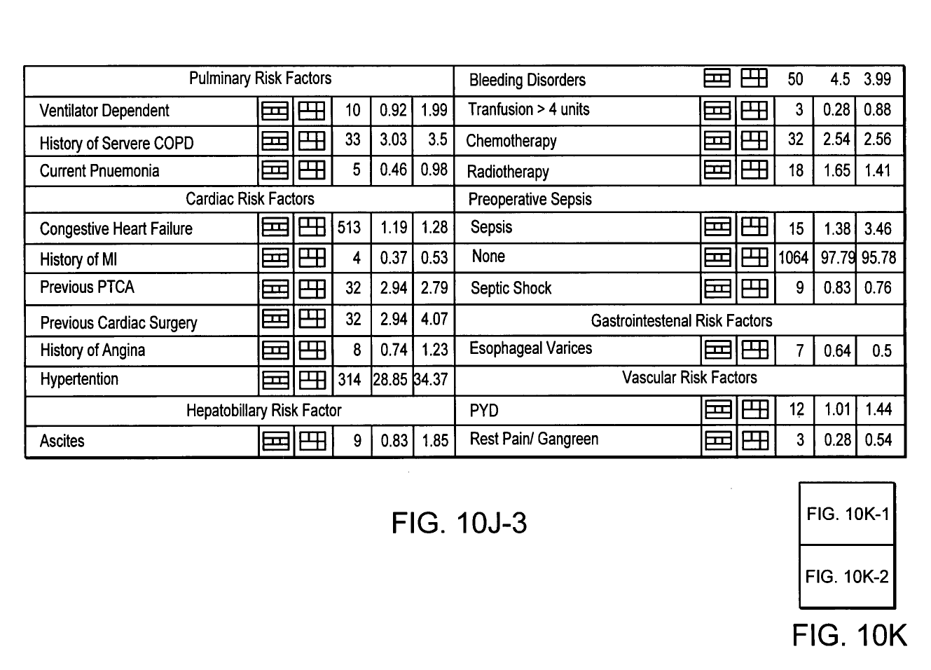

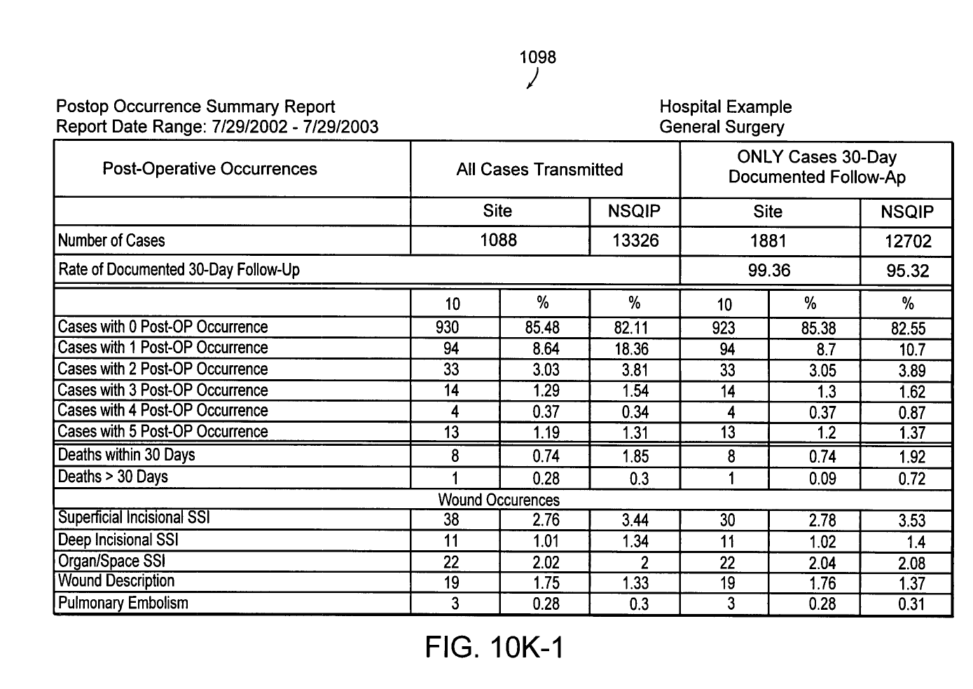

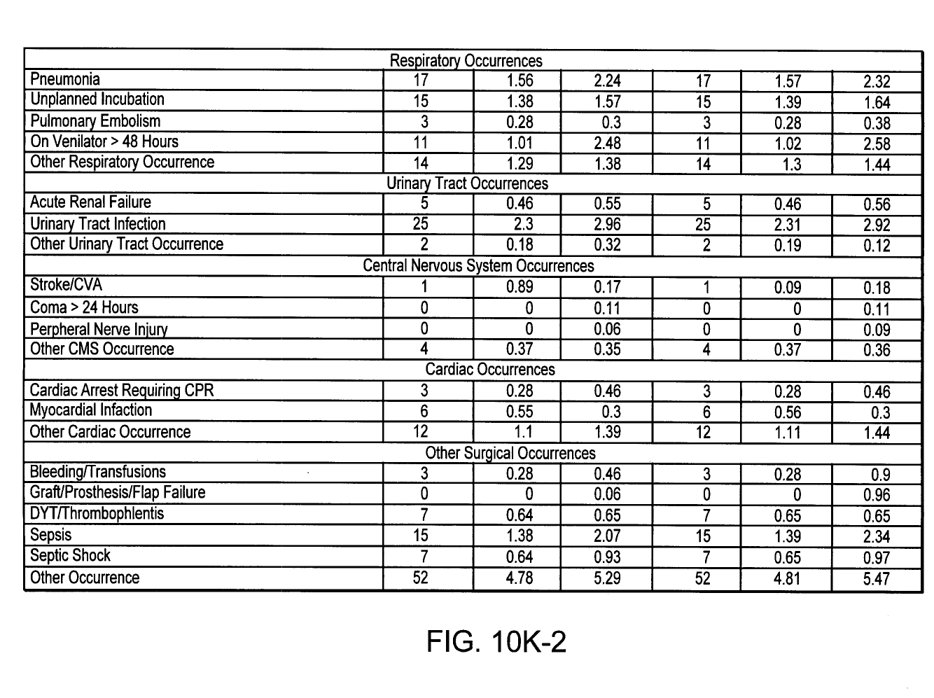

FIG. 10A illustrates an exemplary method for employing a care monitor 232 to plan resource usage. An operator enters values for variables that are needed by predictive functions for calculating a probability of occurrence for adverse events such as post-operative complications (step 1002). Then probabilities of various adverse events are calculated (step 1004). Computed probabilities are presented to an operator (step 1006). Additional information may be provided to an operator depending on their level of training and expertise (step 1008). For example, a user enters all the pre-operative risk factors prior to a surgical operation including the specific operation. The system uses various predictive functions (produced by the Analysis module as described in the previous session on the Feedback Processor) to calculate the probabilities of operation complications and morbidities. The computed values (e.g. probability of mortality, probability of infection, probability of pneumonia, etc.) are returned. If the user is a patient, information about the various complications and alternative methods of treatment can be produced for the patient. If the user is a surgeon, aside from the material produced for the patient, additional materials (e.g. preventive interventions, names of other surgeons, etc.) can be produced.

FIG. 10B illustrates an exemplary user interface display 1010 showing patient identification data 1012 along with risk data 1014 and detail buttons 1016 for providing additional data to an operator.

Care monitor 232 may also perform financial analyses associated with risk factors. FIG. 10C illustrates an exemplary method for performing financial analysis using care monitor 232. An operator specifies a start date and an end data for the analysis (step 1020). The system retrieves all cases containing adverse events within the specified data range (step 1022). For each retrieved case, work units due to adverse events are separated from work units that are normal in the course of events (step 1024). Next, costs and charges are calculated for work units due to adverse events and which are directly caused by the adverse events (step 1026). Statistics are used to make proportionate costs and charges for work units that cannot be clearly delineated (step 1028). A receivable is calculated by multiplying a discount rate to the charges (step 1030). A total loss, or gain, is the result of subcontracting the total receivables from the total costs due to adverse events (step 1032).

Exemplary data structures for implementing the method of FIG. 10F are illustrated in FIG. 10D.

To demonstrate the process in the hospital environment, the cost of postoperative complications can be calculated. For example, if a patient undergoes an operation (e.g., hernia repair) and post-operative pneumonia occurs, extra lab tests (e.g., chest X-ray) may be required and additional antibiotics may be prescribed. Therefore, the costs and charges of this particular case are then the costs and charges for the X-rays and the antibiotics. Because of the complication, the patient also stayed in the hospital longer. However, the exact number of extra days of stay due to pneumonia may not be known. So in this case, historical data are analyzed to find out the average length of stay for patients having hernia operations. The number of days of stay due to complication is then the number of days of stay by this patient subtracted by the average number of days of stay for a patient without complications. After the total costs and charges are computed, the receivable is then the total charges multiplied by the discount rate for this patient's payor. Finally the loss (or gain) due to this case of pneumonia complication is the total cost minus the receivable.

Care monitor 232 further employs additional user interfaces useful for displaying still other types of data related to patient care. For example, care monitor classes may be defined at the system level and then used to facilitate display of data. An example of a system defined monitor class for displaying values of a single variable is shown below:

Time Series for a Simple Variable: To Show the Values of a Single Variable

Properties:

Start time and date—start time and date for data capture
End time and date—end time and date for data capture
Data refresh rate—how often to refresh the object if the end time is set to “present”
Display mode—chart, graph, or data table
Title
Size
x coordinate on screen
y coordinate on screen
Variable to track
Time cycle—daily, weekly, monthly
   A time series monitor object can be formed and used, for example, to facilitate a user display showing data related to hernia operations for a determined time interval. Alternative, a care monitor class such as that shown below:

Time Series of O/E Graph

Properties

Start time and date—start time and data for data capture
End time and date—end time and date for data capture
Data refresh rate—how often to refresh the object if the end time is set to “present”
Display mode—graph
Title
Size
x coordinate on screen
y coordinate on screen
Variable to track
Time cycle—daily, weekly, monthly
   may be used to facilitate display of time series data associated with an observed/expected (O/E) mortality graph covering a determined time span.

FIG. 10F illustrates an exemplary O/E mortality graph. In FIG. 10F, the center of each vertical bar represents the O/E value and the two end points represent values at the 95% confidence level. In FIG. 10F, the observation value may represent the actual number of mortalities for a given month as obtained from a database and the expected value is the number of mortalities for the same month as calculated by a predictive function. An of O/E 1.0 would represent a normal case using the above criteria.

Care monitor 232 may also include an alert monitor for tracking the value of a defined variable. When the value of the variable falls below a defined threshold, an alert may be triggered. The alert monitor may run as a background process so as not to interfere with operation of the system. In addition, the alert may be displayed on a monitor. The alert monitor may further perform trend analysis with an alarm being activated when a projected value falls out of a defined range.

The alert monitor may have properties representing fields containing data for configuring a particular alert monitor embodiment. For example, the alert monitor may have properties such as those shown below:

Properties:

Start time and date—start time and date for data capture
End time and date—end time and date for data capture
Data refresh rate—how often to refresh the object if the end time is set to “present”
Title
Size
Variable to track
Time cycle—hourly, daily, weekly, monthly, or customized
Permissible range—alert triggers if the value of the variable falls outside the permissible lower and upper bounds
Trend analysis—yes or no
Type of alert: email or pager
Email address
Pager number

As described herein, care monitor 232 displays quasi real-time or real-time data to hospital personnel regarding clinical quality indicators and financial/administrative data residing at the local site 202. The monitor objects and classes used to implement care monitor 232 are created at local site 232.

FIG. 10G illustrates a method for creating and using monitor objects in accordance with a preferred embodiment. The method determines whether a new monitor object should be created (step 1050). If an object should be created, a new object is created (step 1052). The monitor class type is entered (step 1054) along with a starting and ending time (step 1056), data refresh rate (step 1058), display mode (step 1060), and a label and title for the new object (step 1062). The new object is then saved.

At step 1050, if a new object should not be created, saved objects are displayed (step 1080). An object is selected from the list (step 1082). Next the user is prompted as to whether the monitor object characteristics are to be changed (step 1084). If the characteristics should be changed, flow goes to the input of step 1056. In contrast, if the monitor object's characteristics should not be changed, data is retrieved and derived values are calculated (step 1068). Method flow also goes to step 1068 after saving an object at step 1064. Data needed in step 1068 is retrieved from local site 202 or central site 212 (step 1066). Data values are displayed according to a display mode selected in step 10680 (step 1070). Next, a determination is made as to whether data refresh is needed (step 1072). If refresh is needed, method flow returns to step 1068. In contrast, if refresh is not needed, an inquiry is made regarding whether the display mode should be changed (step 1076). If the display mode should be changed, a display mode is selected (step 1074). If the display mode should not be changed, the method waits for additional user commands (step 1078).

FIGS. 10H-K illustrate exemplary reports generated using an embodiment of care monitor 232. FIG. 10H illustrates a chief of surgery summary report 1080. Report 1080 contains data associated with total surgical volume 1082, observed vs expected morbidity 1084, 30 day morbidity, observed mortality 1088, mortality summary 1090, and surgical length of stay 1092. Report 1080 may contain tabular data as well as graphical data that reflect surgical outcome data.

FIG. 10I illustrates an administrative summary report 1094. Report 1094 can contain surgical outcome data associated with the surgery type, surgical volume, surgical revenue and morbidity as well as other data.

FIG. 10J contains a pre-operative risk factors summary report 1096 containing data useful for assessing the re-operative condition of patients admitted to the hospital. FIG. 10K contains a post-operative occurrence summary report 1098.

Central site 212 collects data from a plurality of local sites 202. FIG. 11 contains a high level method diagram showing the operation of central site 212. Data is collected from local sites according to rule sets (step 1102). Collected data is stored in temporary or permanent data storage (step 1104) and analyzed using specially developed algorithms (step 1106). Feedback functions can be applied to analyzed data and used to influence collection and formatting of existing data or newly collected data (step 1110). Analyzed data is displayed on a display device (step 1108).

Feedback processor 250 provides derived data back to local site 202 to influence the operation of software applications operating on the local site 202.

For example, the “Care Monitor” module in the local site computes probabilities for adverse events based on certain risk factors using formulas of the form F(z) which is based on stepwise logistic regression analysis. A preferred embodiment uses a logistic function defined as
F(z)=1/(1+e^{(-z)}) where z=b₀+b₁x₁+b₂x₂+ . . . +bₙxₙ.
And the b's are parameters and coefficients of the predictor variables which are estimated by the data in the central store, whereas the variable x's represent the individual risk factors defined in the database schemas. In the data diagram illustrated below, many of the event outcomes can be predicted by their corresponding F(z) functions based on the preoperative risk factors. Such regression methods are widely used by bio-statisticians.

As another example, certain programs in the “Care Monitor” may contain branching condition of the form “IF x<a DO . . . ELSE . . . END_IF” where the value of a is a constant computed by the “Data Analysis” module and x is a program variable in the software or defined in a table schema.

The Feedback Processor 250 periodically sends a request to the “Data Analysis” module to re-compute the constants and passes the new values back to the “Care Monitor”. The method of transmission from the Feedback Processor can be implemented either via asynchronous messages originated from the Feedback Processor 250 or via periodic polling by the “Care Monitor”. The Feedback Processor 250 flowchart is illustrated as follows.

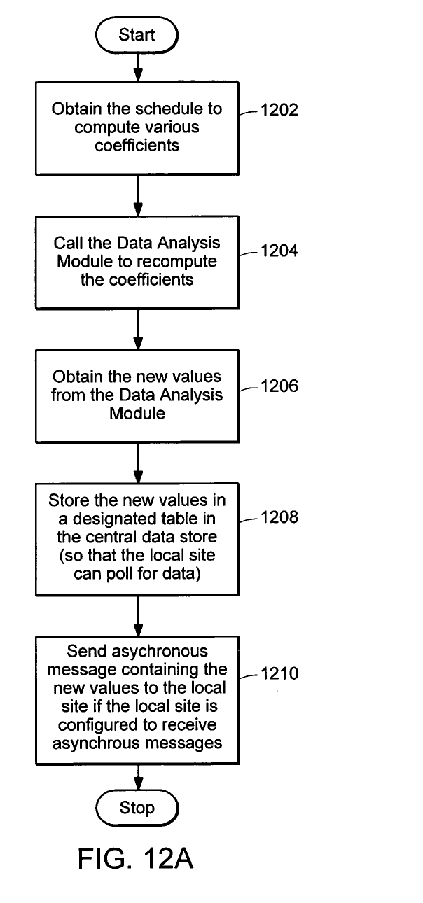

FIG. 12 illustrates an exemplary method executed by feedback processor 250. A schedule is obtained, for example from local site 202, for computing relevant coefficients (step 1202). Then the data analysis module 258 is called in order to re-compute the coefficients (step 1204). The data analysis module 258 generates new values which are passed to feedback processor 250 (step 1206). New values are stored in a designated table in the central data store 264 and made available to local site 202 by way of polling (step 1208). Next, an asynchronous message containing the new values is sent to local sites configured to receive them (step 1210).

FIG. 12B illustrates an exemplary user interface useful for performing regression analysis and prediction on patient data in conjunction with feedback processor 250. Central site 212 includes an Internet interface and security module 242. Module 242 includes, among other things, a fire wall. After a request has passed the firewall, any typical HTTP operation is served up by a standard server such as the Microsoft Internet Information Server. The HTTP server will handle requests for port numbers 80 (HTTP) and 143 (SSL). For a special operation (e.g. Data Automation from a local site), a dedicated port is assigned on the central server to handle the request. For example, a server such as the Attunity Connect Server may be used to listen to the assigned port and process Data Automation requests.

At the Microsoft IIS server, ASP pages corresponding to the HTTP requests are processed. If scramble ID is required, the “Data Blinding” routine is invoked. If data needs validation the rules in the Data Validation routine is invoked. If data access (either retrieval or storage) is required, the Data Access Module is called. Finally, a HTML page is returned.

At the Attunity Connect Server, the request is sent to the Pin Adapter if a scrambled ID is needed. The pin adapter is an Attunity Connect application adapter that wraps a VB component “Data Blinding” within the “Data Input” module running on the server. The VB component implements the pin scramble/unscramble (see details in the Data Blinding section). This central server side hosting allows the VB code to be reused and changed without redeploying the local clients. If the request is any other valid Attunity Connect API then the request is sent to the Attunity Loader. The loader provides the ability to submit both insert and update commands simultaneously and directly to the global data store.

At the system level, firewall and VPN tunneling are provided so that only certain designated services (i.e. ports) are open. The firewall uses technology based on stateful inspection, securing against intruders and DoS attacks. The configuration is designed to prevent attacks from the outside. Using encrypted keys, secure VPN tunnels to the servers can be established.

The intrusion detection software detects changes to server data, whether from outside or from within, and generates alerts and notifications based on a set of rules. It identifies potential intentional tampering, software failure, and introduction of malicious software. A real-time server monitoring solution informs users of the status of key aspects of the servers and the web environment. Automated alerts are triggered if rules are compromised. If a serious incident is identified, a user can execute an incident specific procedure, which might include isolating the system, notifying appropriate technical staff, identifying the problem, and taking the necessary action to resolve the specific issue.

Vulnerability Scanning can be run on the NSQIP web and database servers in connection with the present inventon. This process analyzes each system for possible vulnerabilities using techniques that include password guessing, network and application level testing, and “brute force.” Upon identification and categorization of known issues, a report is produced that details the issues and provides a list of suggested corrective actions. Once these actions have been implemented, the scan is performed once more in order verify that the vulnerabilities have been addressed.

At the application level, all users are assigned usernames and passwords. Users must pass an authentication check before they are allowed to enter the system. Data and operations are partitioned by rings of progressively more secured protections so that a user can only access the data and operations pertaining to that user's access privilege level and above.

Finally, all data at the central site are de-identified by the data blinding process so that even if the data at the central site is accidentally disclosed or stolen, the data cannot be used to trace back to the true identities of the people from whom the data originated.

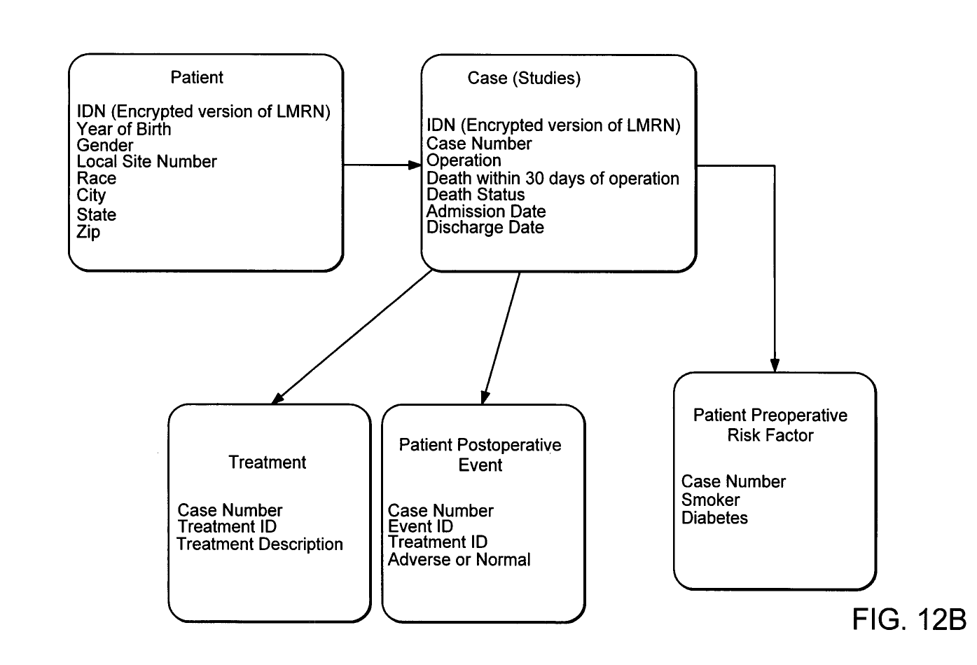

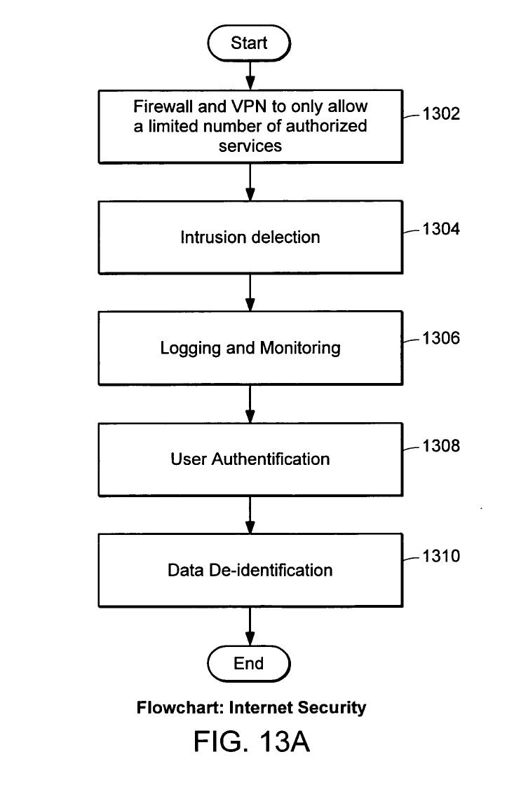

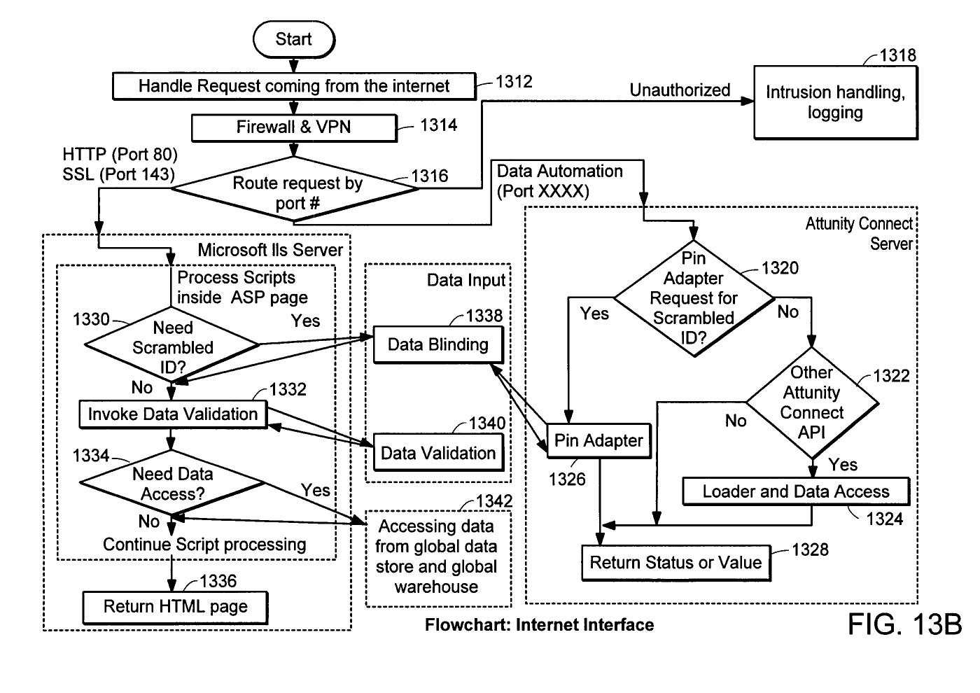

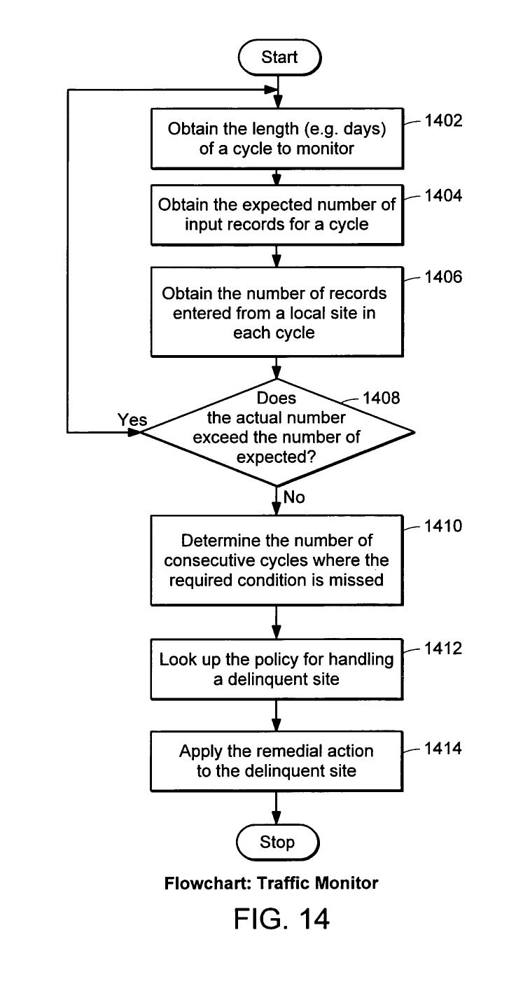

FIG. 13A illustrates a top level method practiced using an embodiment of module 242. A determined number of authorized services are allowed using a firewall and virtual private network (VPN) (step 1302). Intrusion detection screens incoming data traffic for malicious activities such as denial of service attacks (step 1304). A logging and monitoring application tracks traffic (step 1306), and a user authentication module verifies incoming traffic allowing only authorized users and traffic through (step 1308).

Incoming data may be de-identified so that source specific attributes cannot be associated with other components of the data (step 1310).

FIG. 13B illustrates a method for practicing aspects module 242 in conjunction with central site 212. Requests received over the Internet are addressed (step 1312). Incoming data is processed using a firewall and VPN module (step 1314). Next a determination is made with respect to routing requests by port number (step 1316). If a request is unauthorized, an intrusion handling and logging module is accessed (step 1318). If traffic should be routed according to a data automation port, a PIN adapter request for a scrambled ID is made (step 1320). If no request is made, an API query is made (1322). If the API query is affirmative, the loader accepts data from global data store 264 (step 1324). If the API query in step 1322 is negative, method flow returns a status or a value (step 1326). At step 1316 if the route requests an HTTP port, a processor for scripts checks to see if a scrambled ID is needed (step 1330). If a scrambled ID is needed, a data blinding operation is applied (step 1338). In contrast, if no scrambled ID is needed, a data validation algorithm is invoked (step 1332). Step 1332 may receive parameters from a data validation store (step 1340). A determination is then made as to whether data access is needed (step 1334). If data access if needed, data is read from global data store 264 or global data warehouse 266 (step 1342). If data access is not needed, an HTML page is returned (step 1336).

Central site 212 also includes a traffic monitor for monitoring data traffic received by central site 212. The method begins by obtaining the length of a cycle to monitor (step 1402). For example, a cycle can be a number of days, weeks, months, etc. Next, an expected number of input records for the cycle is obtained (step 1404). Then the number of records entered from a local site is obtained for each cycle (step 1406). A query is made to determine if the actual number exceeds an expected number of elements (step 1408). If the actual number exceeds the expected number, method flow returns to the input of step 1402. In contrast, if the actual number does not exceed the expected number, the method determines the number of consecutive cycles where the required condition is missed (step 1410). Then a look up of a policy for handling a delinquent site is performed (step 1412). Then any necessary remedial action is applied to the delinquent site (step 1414).

Data scrubbing is utilized to repair or delete individual pieces of data that are incorrect, incomplete or duplicated before the data is passed to a data warehouse 238, 266 or another application.

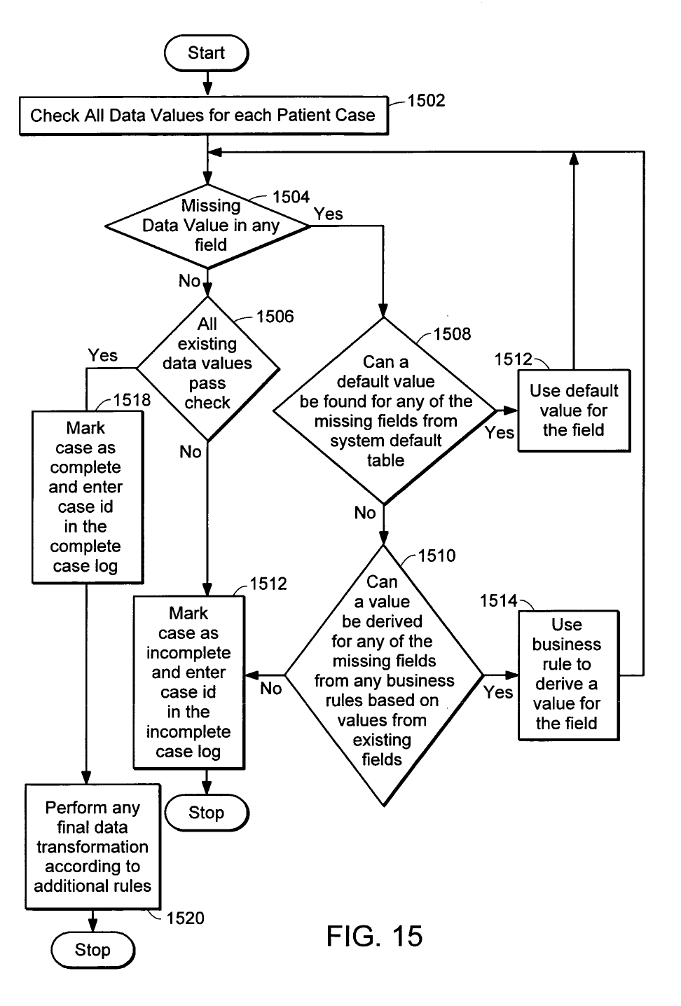

FIG. 15 illustrates a method for performing data scrubbing in an embodiment. The method begins when the data scrubbing utility checks all data values for each patient case (step 1502). Then a check is made to determine if any fields contain missing data (step 1504). If no missing data is detected, a determination is made as to whether all existing data values pass a checking procedure (step 1506). If a missing data value is detected in step 1504, a check is made to determine if a default value can be found for any of the missing fields (step 1508). For example, system default tables may be checked for values. Default values are used if they are found (step 1512). In contrast if default values are not found, a check is made to determine if a value can be derived from any of the missing fields from any business rules based upon values in existing fields (step 1510). The business rules are used to derive a value for the field if possible (step 1514).

In step 1506, if all existing data values pass check, a case is marked as complete and the case ID is entered in the case log (step 1518). In contrast, the case is marked as incomplete and entered into the incomplete case log if al existing data values pass check in step 1506 (step 1516). After step 1518, any final data transformation is performed according to additional rules.

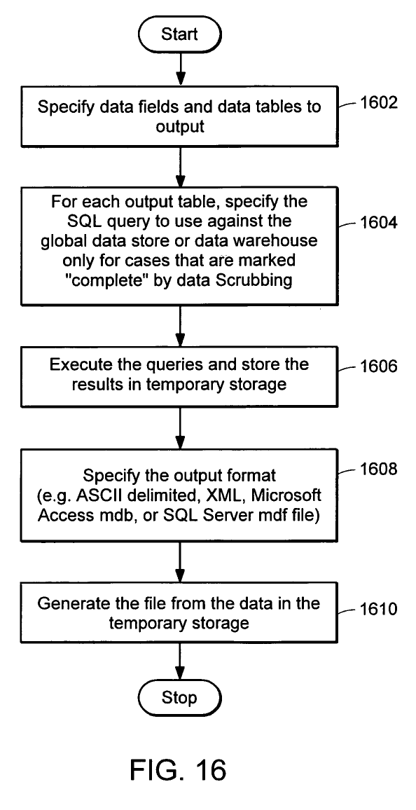

Data export module 254 extracts data from central site 212 and outputs the data to external systems. FIG. 16 illustrates an exemplary method for implementing data export module 254 in an embodiment. An operator specifies the output format by way of data tables and fields (step 1602). For each output table, the user specifies an SQL query to use against the global data store or warehouse only for cases that are marked as “complete” by data scrubbing module 256 (step 1604). The queries are executed and the results are stored in temporary storage (step 1606). Then the output format is specified (step 1608). And, the file is generated from data in temporary storage (step 1610).

Data monitor module 248 ensures that a steady stream of data is transferred from the local sites 202 to the central site 212. Whenever, a local site 202 fails to deliver the agreed upon volume of data to the central site 212, an alert is sent to that local site 202. The alert escalates if the problem persists over several periods; the first alert goes to the user responsible for the data entry at the local site 202, the next alert goes to the user's supervisor, and the third alert goes to the central supervisory committee.

For example, in an exemplary policy, each site must submit a certain number of cases per period. In order to ensure the statistical viability of the NSQIP, each participating site must meet a goal of <N> assessed and transmitted cases per year. This number allows sufficient statistical confidence for the generation of that site's annual report and its O/E ratio. A site that is unable to maintain a rate of data collection for <N> cases per year may be dropped from inclusion in the NSQIP.

The goal of <N> cases per year requires entry of <x> cases per 8-day cycle (using 8-day cycle as an exemplary period). There are 46 8-day cycles in a year, and the site nurses will not be required to enter data for cycles when they are on vacation. For the purpose of the NSQIP we are expecting 4 weeks of vacation, leaving 42 8-day cycles. <y> cases per cycle* 42 8-day cycles per year allow us to reach the goal of <N> cases per medical center. The sites that have less than <y> qualified cases in a cycle are expected to collect 100% of the qualified cases for that cycle. For the purpose of discussion, we'll use a number such as 40 for <y>.

Monitoring procedures utilized in embodiments assist the sites in obtaining the <N> cases to ensure statistical accuracy. These procedures proactively identify any accrual issues on a weekly basis before the medical center falls too far behind its objective of <N> cases sampled per year. These procedures verify that each site is:
Following the 8 day cycle process correctly for random sampling purposes; and
Entering the required of number of cases for the 8 day cycle
Completing and transmitting the minimum number of cases required per 8 day cycle

Each site may be monitored to ensure that it is entering the required minimum number of 40 cases per 8-day cycle. To ensure that the site is adhering to the required sampling protocol, the operation dates will be monitored. Monitoring the 8-day cycle provides the NSQIP with a view of the “pipeline” of cases that will eventually be completed and transmitted. It is the Accrual Report, discussed below, that validates that the sites are completing and transmitting cases at the rate of 40 cases (or maximum cases) per 8-day cycle.

A steering committee may receive a comprehensive site report once per week, detailing the number of cases each site entered into the study and on which day for that cycle. Each medical center has online access via the NSQIP web application to their site's 8-day cycle report. Each reviewer has been asked to review their status each Monday and to catch up or correct any errors giving rise to the flag by Friday of that same week

To ensure that no false flags are raised, each site will be required to inform the Nurse Coordinator whenever they anticipate missing a cycle due to vacation or have a maximum number of cases in a cycle that is less than 40.

An Assistant National Nurse Coordinator (ANNC) will complete the following actions for missed cycles (a cycle is considered “missed” when less than 40 cases are entered in that cycle):
Each site is expected to self-monitor and correct if they have one or two misses.
   3rd miss: Level 1 notification email from Assistant National Nurse Coordinator to the reviewer(s) at the site to notify them of the problem.
   4^{th} miss: Email from Assistant National Nurse Coordinator to the nurse(s) at the site with cc to the site's PI. At this point, the site PI should assist in finding a resolution.
   If these misses are not corrected or further misses are noted, a level 3 notification will be sent to the reviewer(s), the PI and the Steering Committee.
All e-mails will offer assistance and request a confirmation. Copies will be kept on file by the service provider.

The service provider will provide assistance at each step to resolve any technical issues that may be impeding the site's ability to meet the requirements for the 8-day cycle. The following is an example of the 8-day cycle report that will be generated for the Nurse Coordinator:

The steering committee will receive a weekly report detailing the number of expected cases entered, completed, and transmitted versus the number of actual cases transmitted for the fiscal year to date. The report is updated each Monday morning. This report will also be available to every site for self-monitoring. Each reviewer has been advised to view their accrual status each Monday and to make amends by Friday. Sites that are behind by the amounts listed below will not be notified for one week allowing them an opportunity to address the problem. If no positive trend in accrual is noted after one cycle, e-mail notifications will be sent on the same level 1-3 system utilized for flagged cycles. Likewise, the notification level of a site will be noted in a column on the accrual report. If a site's accrual status positively improves after receiving a notification that site's notification level will revert to zero.

The Assistant National Nurse Coordinator will complete the following actions for sites that are falling behind the minimum necessary objective:
Accrual is 4% behind goal: Level one notification e-mail from the Assistant National Nurse Coordinator to the reviewer(s) at the site to determine the problem and find a resolution.
Accrual is 6% off goal: Level two-notification e-mail from Assistant National Nurse Coordinator to the reviewer(s) at the site with cc to the PI. At this point, the site's PI is urged to assist in finding a resolution.
Accrual is 8% off goal: Level three notification e-mail from National Nurse Coordinator to the reviewer(s) with a cc to the Steering Committee and the sites' Principal Investigator. At this point, the Steering Committee will discuss what action to take to ensure a resolution to the situation.

All e-mails will offer assistance and request a confirmation.

Note: If a medical center remains 10% or more off its goal over a period of one month, the Executive Committee will be notified and will consider what actions need to be taken, including, at its discretion, disqualifying the medical center from further participation in the NSQIP.

The table below shows how far off from the minimum required sample size each 2% increment represents.

| Percentage less than goal of <N> | Number of cases entered |
|---|---|
| 4% | 1612 |
| 6% | 1580 |
| 8% | 1545 |
| 10% | 1512 |

The accrual report will take into account the 60 days allotted to the nurse reviewers to complete collection of the 30-day postoperative data for a surgical case and have it transmitted. With this in mind, the accrual report that is generated on any given week will only count in the “Expected” column those cycles whose operation dates were at least 60 days prior to the date of that report.

The following is an example of the weekly accrual report that will be generated.

The NSQIP Executive Committee and the Steering Committee will receive the weekly accrual report. The review and discussion of this report along with any alerts generated from these procedures would be an agenda item for each Executive Committee and Steering Committee meeting. The provider will email this report directly to the committee members one day before each committee's meeting.

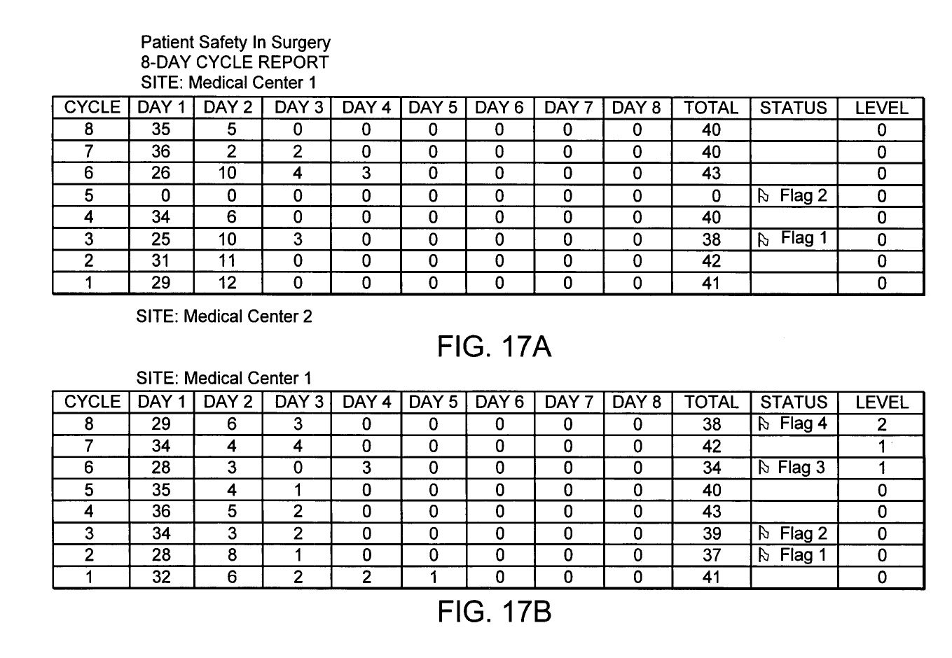

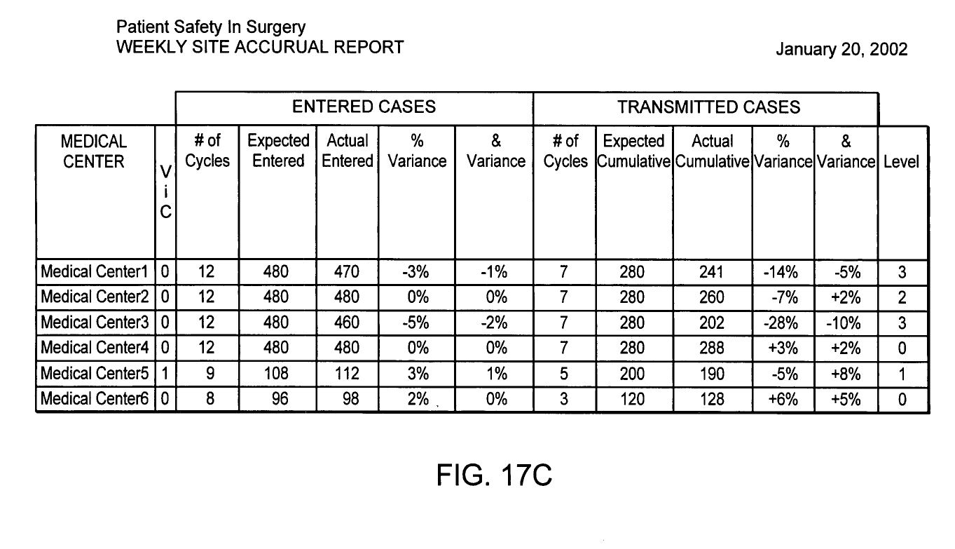

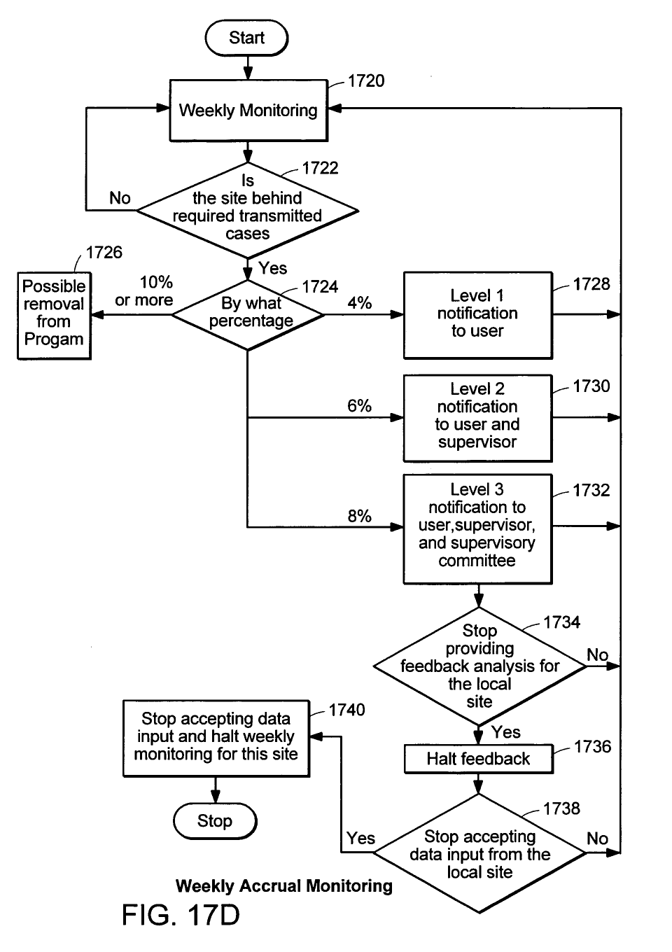

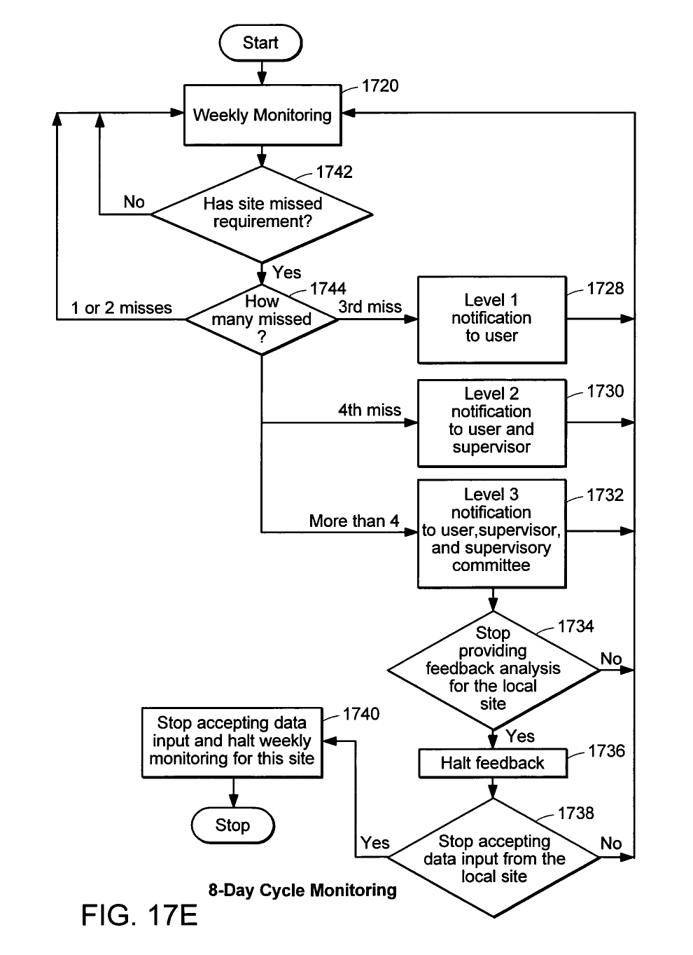

FIG. 17D illustrates an exemplary method for performing weekly accrual monitoring. The method begins when weekly monitoring is selected (step 1720). Then a determination is made as to whether the site is behind regarding its required number of transmitted cases (step 1722). If the site is not behind, the method returns to step 1720. In contrast, if the site is behind, a determination is made as to the percentage of cases that have not been reported (step 1724). If the site is behind by more than 10%, a possible removal step is executed (step 1726). If the site is behind by 4%, a level 1 notification may be sent to a user (step 1728), if the site is behind by 6% a level 2 notification may be sent to a user and a supervisor (step 1730), and if the site is behind by 8% a level 3 notification may be sent to the user, a supervisor and a supervisory committee (step 1732).

A query may then be made to determine if feedback analysis should no longer be provided to local site 202 (step 1734). If feedback should no longer be provided, feedback is halted (step 1736). Then a query is made to see if data should no longer be accepted from the local site 202 (step 1738). If data should no longer be accepted, weekly monitoring for the local site is halted and no input data is accepted (step 1740).

A method for performing weekly accrual monitoring was illustrated in FIG. 17D. 8-day cycle monitoring is performed in substantially the same way as shown in FIG. 17E. Steps 1742 and 1744 differ from the steps of FIG. 17D. In step 1742, a determination is made as to whether a site missed a requirement. If a requirement was missed, then a determination as to the number missed is made (step 1744). The alert notifications of FIG. 17E are like those of FIG. 17D, namely steps 1728, 1730 and 1732.

System 200 may also include a module for ensuring that data entered into NSQIP systems is done in a consistent and reliable manner. Embodiments employ an inter rater reliability (IRR) module 270. IRR module 270 may consist of hardware, software and activities conducted by people, such as audits of local sites 202.

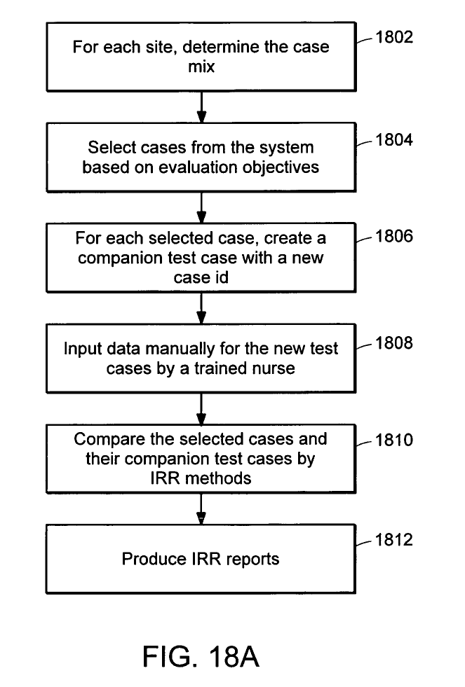

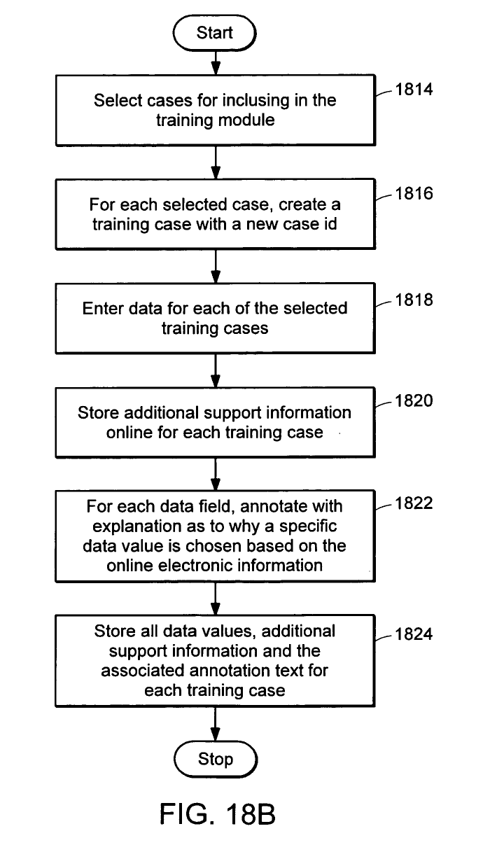

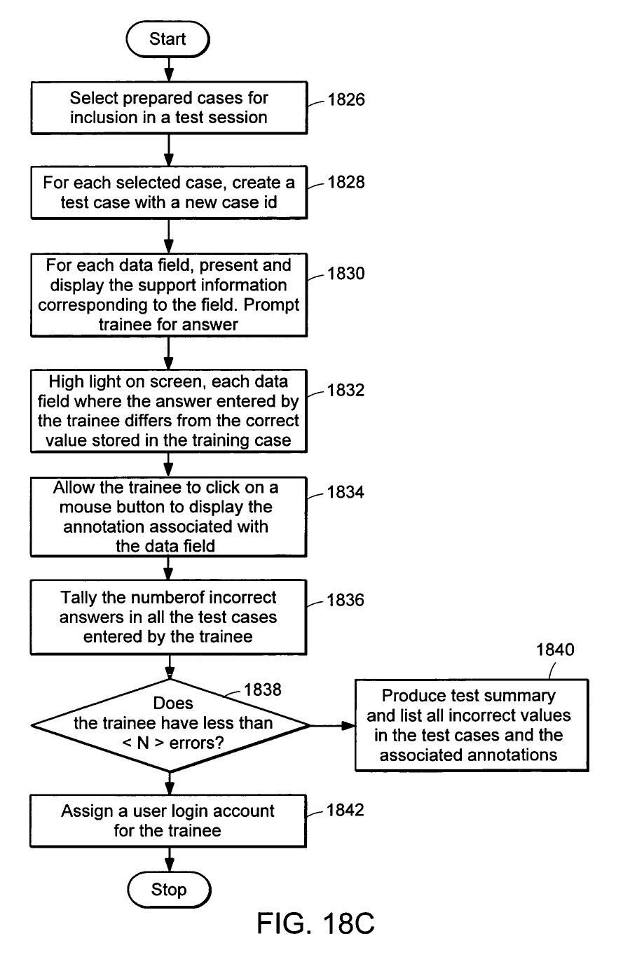

FIG. 18 illustrates a top level method diagram of an embodiment of IRR module. For each site, a mix of patient cases is selected (step 1802). For example, a case list containing approximately 24 charts may be generated by an auditor prior to visiting a site 202. The list may consist of 12 charts (50%) that are randomly selected, 6 charts (25%) having the highest number of pre-operative risk factors, and 6 charts (25%) having the highest number of post-operative occurrences. During a site visit, an auditor may review each selected chart and enter relevant data into system 200 (step 1804). For the selected cases, new cases are created that have fictitious IDN to the case (step 1806) the fictitious IDN is made up a combination of the hospital's site ID and the case number of the specific case that is being reviewed. Next an operator, or nurse, inputs data manually for new test case (step 1808). The selected cases and their companion cases are then compared using IRR analytical techniques (step 1810). IRR reports are then produced for review (step 1812).

The variables collected in the NSQIP program have been placed into three separate categories. Each of these categories implements a different statistical methodology for the comparative analysis. The three statistical methodologies used are:
Percentage of Agreement
Kappa
Intraclass Correlation
   Percentage of Agreement

Percentage of Agreement is used for the comparative analysis of all date and time variables. Percentage of Agreement is defined as:

$$\frac{Number of Agreements}{Number of Observations} = Percentage of Agreement$$

Agreement Measures for Percentage of Agreement

| Percentage of Agreement | Strength of Agreement |
|---|---|
| <.90 | Poor |
| .90-.95 | Substantial |
| .96-1.0 | Almost Perfect |

Kappa

Kappa statistics are implemented for the analysis of all NSQIP multivariate variables. Kappa is defined as:

$$\frac{( {P}_{o} - {P}_{c} )}{( 1 - {P}_{c} )}$$

where Po=observed proportion of agreement=(O₁₁+O₂₂+ . . . +Oₚₚ)/0. Pc=proportion of agreement expected by chance alone=(E₁₁+E₂₂+ . . . Eₚₚ)/E.

$${E}_{ij} = \frac{{O}_{i .} * {O}_{. j}}{{O}_{..}}$$

Agreement Measures for Kappa

| Kappa Statistic | Strength of Agreement |
|---|---|
| <0.00 | Poor |
| 0.00-0.20 | Slight |
| 0.21-0.40 | Fair |
| 0.41-0.60 | Moderate |
| 0.61-0.80 | Substantial |
| 0.81-1.00 | Almost Perfect |

Intraclass Correlation

The third and final methodology used to determine measurement error is the Intraclass correlation method. This method is used on all numerical data collected in the NSQIP program.

Intraclass correlation is defined as:

$$\frac{\hat{O}}{1 + \hat{o}}$$

$\hat{O} = \frac{{MS}_{b . people} - {MS}_{w . people}}{2 * {MS}_{w . people}}$

| | |
|---|---|
| $\begin{matrix}j \\ {MS}_{b . people} = [ \frac{{\sum }_{i = 1}^{n} {x}_{i .}^{a}}{2} - \frac{{x}_{…}^{2}}{2 π} ] / \\ ( n - 1 )\end{matrix}$ | $\begin{matrix} \\ {MS}_{w . people} = [ {\sum }_{i - 1}^{2} {\sum }_{j - 1}^{n} {x}_{ij}^{a} - \\ \frac{{\sum }_{i = 1}^{n} {x}_{i .}^{a}}{2} ] / n\end{matrix}$ |

Agreement Measures for Intraclass Correlation

| Intraclass Correlation | Strength of Agreement |
|---|---|
| <0.00 | Poor |
| 0.00-0.20 | Slight |
| 0.21-0.40 | Fair |
| 0.41-0.60 | Moderate |
| 0.61-0.80 | Substantial |
| 0.81-1.00 | Almost Perfect |

Data entry training may be provided to operators of site 202 to ensure that data is properly entered for NSQIP processing. FIGS. 18B and 18C illustrate exemplary methods for providing training consisting of a computer driven training program (FIG. 18a) for preparing training cases, and an operator screening test program (FIG. 18B).

In FIG. 18A, cases are selected for inclusion in the training module (step 1814). Then a training case is created containing a new case ID for each selected case (step 1816). Data is entered for each selected training case (step 1818). Then additional support information is stored online for each training case (step 1820). Next an annotation is made for each data field (step 1822). The annotation provides an explanation as to why a specific data value is chosen based on the online electronic information. All data values are stored along with additional support information and the associated annotation text for each training case (step 1824).

In FIG. 18B, prepared cases are selected for inclusion in an assessment session (step 1826). For each selected case, a new case ID (step 1828) is created. Support and display information for each field is presented to a trainee for each field and the trainee is prompted for an answer (step 1830).

If answers entered by the trainee differ from the correct values, those data fields are highlighted (step 1832). The trainee may click a mouse button to display the annotation associated with the field (step 1834). Next, the number of incorrect answers is tallied for all cases entered by the trainee (step 1836). A determination is made as to whether the trainee has less than a threshold number of incorrect answers (step 1838). If the number is not less than the threshold, a summary report is produced listing all incorrect values in the cases along with the respective annotations (step 1840). In contrast, if the number of incorrect answers is below the threshold, a user log in account is provided in the trainee (step 1842).

The system allows system administrators to store customized data elements unique to each individual local site. These customized data elements are unique to each site and are not transmitted to the central site. This feature expands the usability of the system by enabling each local site to add site dependent data elements to the system. For instance, in the case of hospitals, a local hospital may wish to add fields that are of interest to the clinicians or accountants at that hospital.

For each physical data table (i.e. a table which is stored in data storage in contrast to a logical table which is realized from physical tables) at the local site level, in addition to the traditional data fields such as gender, sex, . . . etc that one would expect to find, <n> additional fields are included with pre-assigned names “Customized_Field_1”, “Customized_Field_2”, “Customized_Field_N”. The type of the customized fields are of the textual data type for flexibility although they can be set to other more specific data types at time of definition of the table schemas.

While the customized fields are predefined in each physical table, they may or may not be used at any of the local sites 202. If a local site wishes to utilize some of these customized fields in some of the tables, a system administrator must create a customization configuration file. This configuration file, if it exists, is read at system initialization time. The configuration file consists of lines where each line specifies a physical table, a customized field name, and the locally defined field title. The following is an example where the first two customized fields in the Demographic table and the fifth customized field in the IntraOperative table are used and given unique names. Example of a customization configuration file:
Demographic, Customized_Field1, Income
Demographic, Customized_Field2, Insurance Class
IntraOperative, Customized_Field5, Clinical Trial Number

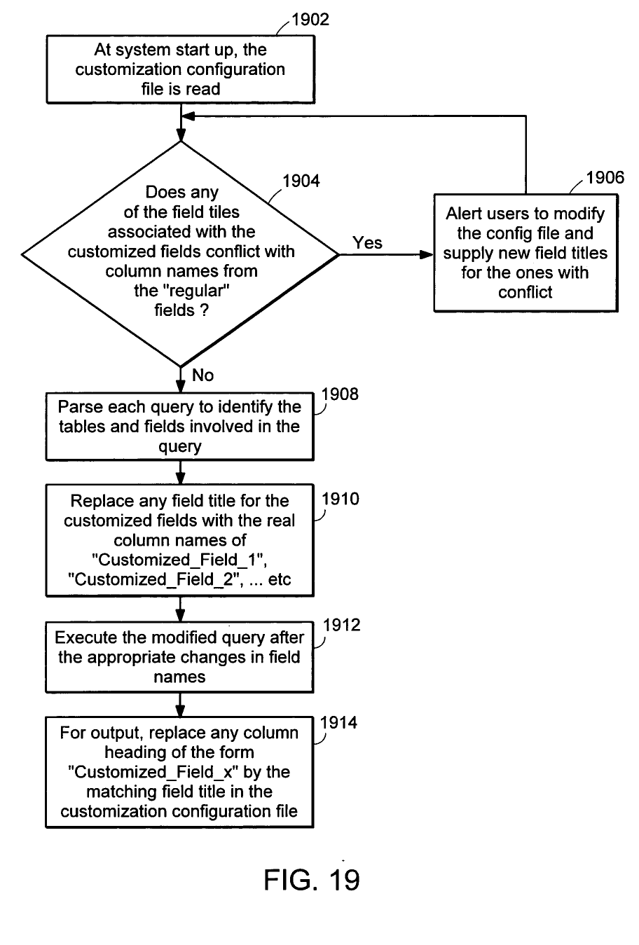

The handling of customized fields is illustrated in FIG. 19. First the customization configuration file is read and validated to make sure that the field titles provided by the administrator do no conflict with real field names in the table schemas. Next during query parsing, any name that matches the field titles provided by the administrator is replaces with the corresponding customized field names (such as Customized_Field_x). The modified query is then executed. For output, any column headings of the form “Customized_Field_x” is replaced by the corresponding field titles provided by the administrator.

FIG. 19 illustrates a method for customizing data fields in accordance with a preferred embodiment. A customization configuration file is read at system start up (step 1902). Then a query is made to determine if any of the field titles associated with the customized fields conflicts with column names from the standard, or regular, fields (step 1904). If a conflict exists, the user is alerted to modify the configuration file by supplying new titles for conflicted fields (step 1906).

If no conflicts are detected in step 1904, each query in the configuration file is passed to identify the tables and fields involved therein (step 1908). Then field titles for the customized fields is replaced with real column names such as Customized_Field1, Customized_Field2, etc. (step 1910). The modified query is executed after the appropriate changes in field names are made (step 1912). For output, column headings of a form Customized_Fieldx” are replaced by the corresponding matching field title in the customization configuration file (step 1914).

Additional features and embodiments may also be implemented in accordance with aspects of the invention. For example, peri-operative data can be gathered, processed, displayed, and distributed using preferred embodiments. Peri-operative refers to the condition of a subject undergoing any type of medical procedure and includes, among other things, pre-operative data, intra-operative data and post-operative data associated with a patient. A data management workstation can be included in the local site or the central site for allowing a user to manually enter data, edit data, send data, store data, and collect data.

A data transport module can be included for extracting data from external sources such as databases and for transforming data to an XML document for transmission to the central site. A local site can include a monitor that receives aggregated feedback data from the central site. The aggregated data can be used to improve procedures and processes at the local site. The local site can include a module for parsing XML documents and for storing data in memory. A data analysis module operating at the central site can produce results for evaluating each of a plurality of local sites. The local sites can be evaluated over a time interval.

Embodiments of the invention can be used in connection with hospitals or any facility providing therapeutic or healthcare services. Data for patients can be collected and processed before procedures, during procedures and after procedures are performed at a facility. The local site and central site can participate in programs other than NSQIP, such as national accreditation programs and programs collecting data from a plurality of local sites. Procedures applied to patients influence the outcome of the patient such as the physical condition of the patient. The central site can process pre-operative data and intra-operative data to formulate relationships. If desired, post-operative data can be included in the relationship as well.

A feedback processor can be used to establish relationships or use data from existing relationships to improve and modify procedures used by local sites when treating patients. The feedback processor can generate a result that includes summary information for each of a plurality of source sites. The information can be stratified by statistical means to remove random processes and noises from data obtained from local sites so that meaningful comparisons can be made. Results can include predictor functions to predict post-operative outcomes based on data associated with pre-operative and intra-operative measurements.

Local sites can be characterized and categorized by geography, size, types of services provided, cost of procedures, etc. A central site may facilitate viewing of results in real time at a local site or at the central site itself. Data collection procedures and methods may be validated for accuracy using statistical sampling techniques. Filtering algorithms and techniques may be employed to remove confidential information associated with patients before transmitting data from a local site to a central site.

Industry standard ODBC and JDBC protocols can be used to extract data from external databases for use by local sites and/or central site. A mapping interface can be used to transform ODBC compliant data into XML schema. A traffic monitor can be used to measure and report on the volume of data transmitted from a local site, or source site, to a central site, or receiving site. In addition, the traffic monitor can include an alert capability for alerting a local site if its traffic falls below a threshold amount. A care monitor can be used to improve procedures and processes at local sites. The care monitor can display graphs on a display device or print results to hardcopy using an attached printer. The graphs and printouts can be in formats that are easy for an operator to understand. The graphs can include time series displays of aggregated results.

The claims should not be read as limited to the described order or elements unless stated to that effect. Therefore, all embodiments that come within the scope and spirit of the following claims and equivalents thereto are claimed as the invention.

1. A system for processing data comprising:
a source site for collecting data pertaining to procedures performed therein;
a receiving site for accepting data from said source site; and
a network coupling said source site to said receiving site.

2. The system of claim 1 wherein said source site is a hospital.

3. The system of claim 2 wherein said receiving site is a central site.

4. The system of claim 3 wherein said central site is participating in the National Surgical Quality Improvement Program (NSQIP).

5. The system of claim 4 wherein said network is the internet.

6. The system of claim 5 wherein said procedures are surgical procedures.

7. The system of claim 6 wherein said receiving site processes said accepted data to produce a result.

8. The system of claim 7 wherein said result is used by a feedback processor operating in conjunction with said receiving site.

9. The system of claim 8 wherein said feedback processor sends a report to said source site.

10. The system of claim 9 wherein said source site uses said report to improve operating procedures associated with said surgical procedures.

11. A method for processing hospital data, said method comprising the steps of:
generating a data set;
transmitting said data set over a network;
receiving said data set at a receiver; and
processing said data set.

12. The method of claim 11 wherein a hospital generates said data set.

13. The method of claim 12 wherein said data set includes patient surgical data.

14. The method of claim 13 wherein said transmitted data is blinded so as to obscure a patient's identity.

15. The method of claim 14 wherein said receiver is a central site participating in the National Surgical Quality Improvement Program (NSQIP).

16. The method of claim 15 wherein the receiver utilizes a feedback processor.

17. The method of claim 16 wherein said feedback processor provides a result to said hospital.

18. The method of claim 17 wherein said hospital uses said result to improve its surgical procedures.

19. The method of claim 11 further comprising providing XML-based data stored at a local site and a central site.

20. The method of claim 19 further comprising providing a plurality of interface programs and a loader at the local site to load data for transmission over the network.

21. A system for collecting and processing peri-operative data comprising:
a source site for collecting data pertaining to procedures performed therein;
a receiving site for accepting data from said source site; and
a network coupling said source site to said receiving site.

22. The system of claim 21 wherein said source site is a healthcare facility.

23. The system of claim 22 wherein said healthcare facility is an outpatient treatment facility.

24. The system of claim 21 wherein said healthcare facility is a hospital

25. The system of claim 21 wherein said procedure is a therapeutic procedure performed on a patient.

26. The system of claim 25 wherein said source site further comprises:
a workstation for entering data, editing data, tracking data, transporting data, storing data and printing data associated with said therapeutic procedure.

27. The system of claim 26 further comprising:
a data transport module for extracting data from an external source for transforming an XML document prior to transmission from said source site to said receiving site.

28. The system of claim 27 further comprising:
a monitor for receiving aggregated feedback data from said receiving site, said aggregated feedback data used by said source site for modifying processes and procedures utilized at said source site.

29. The system of claim 28 further comprising:
a module operating in conjunction with said receiving site for parsing said XML document and for storing data associated therewith in a memory, said memory further used in conjunction with a data analysis module for manipulating said data associated with said XML document.

30. The system of claim 29 wherein said data analysis module generates a result used for evaluating said source site against a determined time period.

31. The system of claim 30 wherein said result is further used to compare said source site to a plurality of other source sites communicatively coupled to said receiving site.

32. The system of claim 31 wherein said source site collects patient data prior to, during and after said therapeutic procedure is performed.

33. The system of claim 32 wherein said receiving site participates in a program having guidelines for collecting and using data obtained from said source site and said plurality of other source sites.

34. The system of claim 33 wherein said network is an Internet network.

35. The system of claim 34 wherein said therapeutic procedure is capable of influencing the outcome of a physical condition associated with said patient.

36. The system of claim 35 wherein said peri-operative data is comprised of:
pre-operative data consisting of data associated with said patient before application of said therapeutic procedure;
intra-operative data consisting of data associated with said patient during the application of said therapeutic procedure; and
post-operative data consisting of data associated with said patient after the application of said therapeutic procedure.

37. The system of claim 36 wherein said receiving site processes said pre-operative data, said intra-operative data and said post-operative data, and wherein said processing involves analyzing a relationship between said pre-operative, intra-operative and post-operative data.

38. The system of claim 37 wherein said relationship is utilized by a feedback processor for improving and modifying the application of said therapeutic procedures to other patients having similar pre-operative or intra-operative data.

39. The system of claim 38 wherein said improving and said modifying produces desirable post-operative outcomes.

40. The system of claim 39 wherein said result includes summary information for said source site and said plurality of other source sites and said summary information is stratified by statistical means to remove random noises from each of said source sites to produce meaningful data capable of use in making comparisons among said source sites.

41. The system of claim 40 wherein said result includes a predictor function for predicting said post-operative outcome based on said pre-operative data and said post-operative data.

42. The system of claim 41 wherein said result is used in conjunction with national benchmarking.

43. The system of claim 42 wherein said result categorizes said source site data according geography, size of said source site and purpose of said source site.

44. The system of claim 43 wherein said summary result is viewable in real-time.

45. The system of claim 44 wherein said feedback processor transmits said summary result to said local site.

46. The system of claim 45 wherein said source site uses said summary data to improve application of said therapeutic procedures.

47. The system of claim 46 wherein a data collection process utilized by said source site may be validated for accuracy using statistical sampling techniques.

48. The system of claim 47 wherein said workstation is a management workstation for allowing a user to manually enter and edit data.

49. The system of claim 48 further comprising:
site specific data filtering for removing confidential information from said data.

50. The system of claim 49 further comprising:
a plurality of external databases communicatively coupled with said source site, said plurality of other source sites, or said receiving site.

51. The system of claim 50 wherein data is extracted from said plurality of databases using industry standard protocols.

52. The system of claim 51 wherein said industry standard protocols include ODBC and JDBC.

53. The system of claim 52 further comprising:
a mapping interface for transforming an ODBC compliant data into an XML compatible schema.

54. The system of claim 53 further comprising:
a traffic monitor for measuring and reporting on the volume of data traffic exchanged between said source site and said receiving site.

55. The system of claim 54 wherein said traffic monitor further sends an alert signal to said local site if said data traffic volume drops below a threshold.

56. The system of claim 55 further comprising:
a care monitor for displaying information useful for improving said therapeutic procedures.

57. The system of claim 56 wherein said care monitor further comprises:
a printer.

58. The system of claim 57 wherein said displayed information includes graphs that are easy for a user to comprehend.

59. The system of claim 58 wherein said graphs contain time series data of aggregated results.
